(19) United States
(12) Patent Application Publication
(10) Pub. No.: US 2012/0245275 A1
(43) Pub. Date: Sep. 27, 2012

(54) PROCESS FOR PRODUCING CONJUGATED DIENE-BASED POLYMER, CONJUGATED DIENE-BASED POLYMER, AND CONJUGATED DIENE-BASED POLYMER COMPOSITION

(75) Inventors: Mana ITO, Ichihara-shi (JP); Katsunari INAGAKI, Ichihara-shi (JP); Mayumi OSHIMA, Chuo-ku (JP)

(73) Assignee: Sumitomo Chemical Company, Limited

(21) Appl. No.: 13/441,690

(22) Filed: Apr. 6, 2012

Related U.S. Application Data
(63) Continuation-in-part of application No. 13/356,561, filed on Jan. 23, 2012, now abandoned.

(30) Foreign Application Priority Data
Jan. 24, 2011 (JP) 2011-011714
Jun. 24, 2011 (JP) 2011-140337

(51) Int. Cl. C08L 83/16; C08F 236/06; C08F 4/48

(52) U.S. Cl. 524/547; 526/173

(57) ABSTRACT

The present invention provides a process for producing a conjugated diene-based polymer comprising adding the following compounds (I) and (II);
(I) Organic alkali metal compound;
(II) Compound represented by the following formula (I)

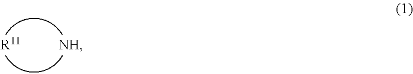

wherein R¹¹ represents a hydrocarbylene group having 3 to 20 carbon atoms optionally having, as a hetero atom, at least one kind atom selected from an atomic group consisting of a silicon atom, a nitrogen atom and an oxygen atom,
as a polymerization initiator component to a solution containing at least one kind monomer component and using a hydrocarbon as a solvent, in an order of the compound (I) and the compound (II), and polymerizing a monomer component comprising a conjugated diene-compound and a silicon-containing vinyl compound.

The present application is a CIP of U.S. application Ser. No. 13/356,561, filed Jan. 23, 2012, which claims priority under 35 U.S.C. §119 to Japanese Patent Application No. 2011-011714 filed on Jan. 24, 2011, and Japanese Patent Application No. 2011-140337, filed Jun. 24, 2011, under the Paris Convention, the contents of which are hereby incorporated by reference in their entirety.

### BACKGROUND OF THE INVENTION

1. Field of the Invention

The present invention relates to a process for producing a conjugated diene-based polymer, a conjugated diene-based polymer, and a conjugated diene-based polymer composition.

2. Description of the Related Art

In recent years, with an increase in concern about environmental problems, requirements of fuel cost saving properties on an automobile have been increasing, and a rubber composition used in tires for automobiles has also been required to be excellent in fuel cost saving. As a rubber composition for automobile tires, a rubber composition containing a conjugated diene-based polymer such as polybutadiene or a butadiene-styrene copolymer, and a reinforcing agent is used.

For example, as a polymer enhancing fuel cost saving properties and a polymer composition having good fuel cost saving properties, a polymer obtained by living anion polymerization of butadiene, styrene and bis(diethylamino)methylvinylsilane using alkyllithium as a polymerization initiator, and a polymer composition containing the polymer and silica are proposed in JP-A 2010-77386. A polymer obtained by adding alkyllithium and hexamethyleneimine to butadiene and styrene, and polymerizing this is proposed in JP-A 9-110942.

### SUMMARY OF THE INVENTION

However, polymer compositions using the above conventional conjugated diene-based polymer were not necessarily sufficiently satisfactory in fuel cost-saving properties.

Under such circumstances, an object of the present invention is to provide a process for producing a conjugated diene-based polymer from which a polymer composition excellent in fuel cost saving properties can be obtained, a conjugated diene-based polymer obtained by the process, and a polymer composition containing the conjugated diene-based polymer and a reinforcing agent.

A first aspect of the present invention relates to a process for producing a conjugated diene-based polymer comprising adding the following compounds (I) and (II) as a polymerization initiator component to a solution containing at least one kind monomer component and using a hydrocarbon as a solvent, in an order of the compound (I) and the compound (II), and polymerizing a monomer component containing a conjugated diene compound and a silicon-containing vinyl compound.
(I) Organic alkali metal compound
(II) Compound represented by the following formula (1):

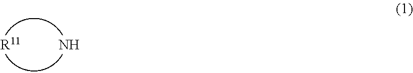

(wherein R¹¹ represents a hydrocarbylene group having 3 to 20 carbon atoms optionally having, as a hetero atom, at least one kind atom selected from an atomic group consisting of a silicon atom, a nitrogen atom and an oxygen atom.)

A second aspect of the present invention relates to a conjugated diene-based polymer produced by the above-mentioned production process.

A third aspect of the present invention relates to a conjugated diene-based polymer composition comprising the above-mentioned conjugated diene-based polymer and a reinforcing agent, wherein the content of the reinforcing agent is 10 parts by weight to 150 parts by weight per 100 parts by weight of the conjugated diene-based polymer.

According to the present invention, there can be provided a process for producing a conjugated diene-based polymer from which a polymer composition excellent in fuel cost saving properties can be obtained, a conjugated diene-based polymer obtained by the process, and a polymer composition containing the conjugated diene-based polymer and a reinforcing agent.

### DETAILED DESCRIPTION OF THE INVENTION

Herein, a hydrocarbyl group represents a monovalent group obtained by removing one hydrogen atom from a hydrocarbon. A hydrocarbylene group represents a divalent group obtained by removing two hydrogen atoms from a hydrocarbon. A hydrocarbyloxy group represents a monovalent group having a structure in which a hydrogen atom of a hydroxy group is replaced with a hydrocarbyl group. A substituted amino group represents a group having a structure in which at least one hydrogen atom of an amino group is replaced with a monovalent atom other than a hydrogen atom or a monovalent group, or a group having a structure in which two hydrogen atoms of an amino group are replaced with a divalent group. A hydrocarbyl group having a substituent (hereinafter, referred to as substituted hydrocarbyl group in some cases) represents a monovalent group having a structure in which at least one hydrogen atom of a hydrocarbyl group is replaced with a substituent. A hydrocarbylene group having a hetero atom (hereinafter, referred to as hetero atom-containing hydrocarbylene group in some cases) represents a divalent group having a structure in which a carbon atom other than the carbon atom from which a hydrogen atom has been removed, and/or a hydrogen atom, of a hydrocarbylene group, is replaced with a group having a hetero atom (an atom other than a carbon atom and a hydrogen atom).

In the process for producing a conjugated diene-based polymer of the present invention, the following compounds (I) and (II) as a polymerization initiator component are added to a solution containing at least one kind monomer component and using a hydrocarbon as a solvent, in an order of the compound (I) and the compound (II), and a monomer component containing a conjugated diene compound and a silicon-containing vinyl compound is polymerized.
(I) Organic alkali metal compound
(II) Compound represented by the following formula (1):

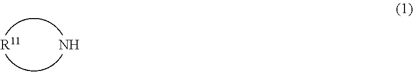

(wherein R¹¹ represents a hydrocarbylene group having 3 to 20 carbon atoms optionally having, as a hetero atom, at least one kind atom selected from an atomic group consisting of a silicon atom, a nitrogen atom and an oxygen atom.)

A solution using a hydrocarbon as a solvent, to which the compound (I) is added, contains at least one kind monomer component. Examples of the monomer component include conjugated diene compounds, silicon-containing vinyl compounds, and aromatic vinyl compounds.

The solution using a hydrocarbon as a solvent, to which the compound (I) is added, is preferably a solution containing a conjugated diene compound.

Examples of the conjugated diene compound include 1,3-butadiene, isoprene, 1,3-pentadiene, 2,3-dimethyl-1,3-butadiene, and 1,3-hexadiene, and preferably 1,3-butadiene or isoprene.

The silicon-containing vinyl compound is preferably a compound represented by the following formula (2):

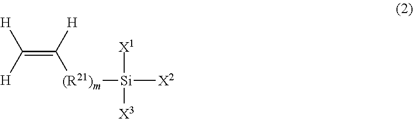

(wherein m is 0 or 1, R²¹ represents a hydrocarbylene group, and X¹, X² and X³ represent a substituted amino group, a hydrocarbyloxy group, or a hydrocarbyl group optionally having a substituent.)

In the formula (2), m is 0 or 1, and preferably 0.

Examples of the hydrocarbylene group in R²¹ include an alkylene group, an alkenediyl group, an aryl group, and a group in which an arylene group and an alkylene group are bonded. Examples of the alkylene group include a methylene group, an ethylene group, and a trimethylene group. Examples of the alkenediyl group include a vinylene group and an ethylene-1,1-diyl group. Examples of the arylene group include a phenylene group, a naphthylene group, and a biphenylene group. Examples of the group in which an arylene group and an alkylene group are bonded include a group in which a phenylene group and a methylene group are bonded, and a group in which a phenylene group and an ethylene group are bonded.

R²¹ is preferably an arylene group and more preferably a phenylene

In the formula (2), X¹, X² and X³ represent a substituted amino group, a hydrocarbyloxy group, or a hydrocarbyl group optionally having a substituent. Preferably, at least one of X¹, X² and X³ is a substituted amino group, and more preferably, two of X¹, X² and X³ are a substituted amino group.

The substituted amino group in X¹, X² and X³ is preferably a group represented by the following formula (2-A).

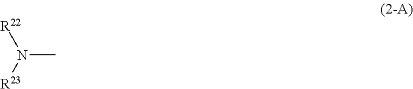

(R²² and R²³ represent a hydrocarbyl group optionally having a substituent, or a trihydrocarbylsilyl group, or R²² and R²³ are bonded to represent a hydrocarbylene group optionally having, as a hetero atom, a nitrogen atom and/or an oxygen atom.)

The hydrocarbyl group optionally having a substituent in R²² and R²³ is a hydrocarbyl group or a substituted hydrocarbyl group. Examples of the substituted hydrocarbyl group include a substituted hydrocarbyl group in which the substituent is a hydrocarbyloxy group. Examples of the hydrocarbyl group include chain alkyl groups such as a methyl group, an ethyl group, a n-propyl group, an isopropyl group, a n-butyl group, an isobutyl group, a sec-butyl group, a tert-butyl group, a n-pentyl group, a n-hexyl group, and a n-octyl group; cyclic alkyl groups such as a cyclopentyl group and a cyclohexyl group; and aryl groups such as a phenyl group, a benzyl group, and a naphthyl group, and preferably an alkyl group, more preferably a chain alkyl group, and further preferably a methyl group, an ethyl group, a n-propyl group, and a n-butyl group. Examples of the substituted hydrocarbyl group in which the substituent is a hydrocarbyloxy group include alkoxyalkyl groups such as a methoxymethyl group, an ethoxymethyl group, and a methoxyethyl group; and aryloxyalkyl groups such as a phenoxymethyl group.

Examples of the trihydrocarbylsilyl group in R²² and R²³ include trialkylsilyl groups such as a trimethylsilyl group, a triethylsilyl group, and a tert-butyldimethylsilyl group.

The hydrocarbylene group optionally having, as a hetero atom, a nitrogen atom and/or an oxygen atom in R²² and R²³ is a hydrocarbylene group, or a hetero atom⁻containing hydrocarbylene group in which the hetero atom is a nitrogen atom and/or an oxygen atom. Examples of the hetero atom-containing hydrocarbylene group in which the hetero atom is a nitrogen atom and/or an oxygen atom include a hetero atom-containing hydrocarbylene group in which the hetero atom is a nitrogen atom, and a hetero atom-containing hydrocarbylene group in which the hetero atom is an oxygen atom. Examples of the hydrocarbylene group include alkylene groups such as a trimethylene group, a tetramethylene group, a pentamethylene group, a hexamethylene group, a heptamethylene group, an octamethylene group, a decamethylene group, a dodecamethylene group, and a 2,2,4-trimethylhexane-1,6-diyl group; and alkenediyl groups such as a pent-2-ene-1,5-diyl group. Examples of the hetero atom-containing hydrocarbylene group in which the hetero atom is a nitrogen atom include a group represented by —CH═N—CH═CH— and a group represented by —CH═N—CH₂—CH₂—. Examples of the hetero atom-containing hydrocarbylene group in which the hetero atom is an oxygen atom include a group represented by —CH₂—CH₂—O—CH₂—CH₂—.

It is preferable that R²² and R²³ are an alkyl group, or R²² and R²³ are bonded to form an alkylene group, it is more preferable to form an alkyl group, and it is further preferable to form a methyl group or an ethyl group.

Examples of a substituted amino group in which R²² and R²³ are a hydrocarbyl group, of the substituted amino groups represented by the formula (2-A), include dialkylamino groups such as a dimethylamino group, a diethylamino group, an ethylmethylamino group, a di-n-propylamino group, a diisopropylamino group, a di-n-butylamino group, a diisobutylamino group, a di-sec-butylamino group, and a di-tert-butylamino group; and diarylamino groups such as a diphenylamino group, and preferably a dialkylamino group, and more preferably a dimethylamino group, a diethylamino group, a di-n-propylamino group, and a di-n-butylamino group. Examples of the substituted amino group in which R²² and R²³ are bonded to form a substituted hydrocarbyl group in which the substituent is a hydrocarbyloxy group include di(alkoxyalkyl)amino groups such as a di(methoxymethyl)amino group and a di(ethoxymethyl)amino group. Examples of the substituted amino group in which R²² and R²³ are a trihydrocarbylsilyl group include trialkylsilyl group-containing amino groups such as a bis(trimethylsilyl)amino group, a bis(tert-butyldimethylsilyl)amino group, and a N-trimethylsilyl-N-methylamino group.

Examples of a substituted amino group in which R²² and R²³ are bonded to form a hydrocarbylene group, of the substituted amino groups represented by the formula (2-A), include 1-alkyleneimino groups such as a 1-trimethyleneimino group, a 1-pyrrolidinyl group, a 1-piperidinyl group, a 1-hexamethyleneimino group, a 1-heptamethyleneimino group, a 1-octamethyleneimino group, a 1-decamethyleneimino group, and a 1-dodecamethyleneimino group. Examples of the substituted amino group in which R²² and R²³ are bonded to form a hetero atom-containing hydrocarbyl group in which the hetero atom is a nitrogen atom include a 1-imidazolyl group and a 4,5-dihydro-1-imidazolyl group. Examples of the substituted amino group in which R²² and R²³ are bonded to form a hetero atom-containing hydrocarbylene group in which the hetero atom is an oxygen atom include a morpholino group.

As the substituted amino group represented by the formula (2-A), a dialkylamino group or a 1-alkyleneimino group is preferable, a dialkylamino group is more preferable, and a dimethylamino group, a diethylamino group, a di-n-propylamino group, and a di-n-butylamino group are further preferable.

Examples of the hydrocarbyloxy group in X¹, X² and X³ include alkoxy groups such as a methoxy group, an ethoxy group, a n-propoxy group, an isopropoxy group, a n-butoxy group, a sec-butoxy group, and a tert-butoxy group; and aryloxy groups such as a phenoxy group and a benzyloxy group.

The hydrocarbyl group optionally having a substituent in X¹, X² and X³ is a hydrocarbyl group or a substituted hydrocarbyl group. Examples of the substituted hydrocarbyl group include a substituted hydrocarbyl group in which the substituent is a hydrocarbyloxy group. Examples of the hydrocarbyl group include alkyl groups such as a methyl group, an ethyl group, a n-propyl group, an isopropyl group, a n-butyl group, a sec-butyl group, and a tert-butyl group; and aryl groups such as a phenyl group, a 4-methyl-1-phenyl group, and a benzyl group. Examples of the substituted hydrocarbyl group in which the substituent is a hydrocarbyloxy group include alkoxyalkyl groups such as a methoxymethyl group, an ethoxymethyl group, and an ethoxyethyl group. Among them, an alkyl group is preferable, and an alkyl group having 1 to 10 carbon atoms is more preferable.

Examples of a compound in which one of X¹, X² and X³ is a substituted amino group and m is 0, of the silicon-containing vinyl compounds represented by the formula (2), include:

(dialkylamino)dialkylvinylsilanes such as (dimethylamino)dimethylvinylsilane, (ethylmethylamino)dimethylvinylsilane, (di-n-propylamino) dimethylvinylsilane, (diisopropylamino)dimethylvinylsilane, (dimethylamino)diethylvinylsilane, (ethylmethylamino)diethylvinylsilane, (di-n-propylamino)diethylvinylsilane, and (diisopropylamino)diethylvinylsilane;

[bis(trialkylsilyl)amino]dialkylvinylsilanes such as [bis(trimethylsilyl)amino]dimethylvinylsilane, [bis(t-butyldimethylsilyl)amino]dimethylvinylsilane, [bis(trimethylsilyl)amino]diethylvinylsilane, and [bis(t-butyldimethylsilyl)amino]diethylvinylsilane;

(dialkylamino)di(alkoxyalkyl)vinylsilanes such as (dimethylamino)di(methoxymethyl)vinylsilane, (dimethylamino)di(2-methoxyethyl)vinylsilane, (dimethylamino)di(ethoxymethyl)vinylsilane, (dimethylamino)di(2-ethoxyethyl)vinylsilane, (diethylamino)di(methoxymethyl)vinylsilane, (diethylamino)di(2-methoxyethyl)vinylsilane, (diethylamino)di(ethoxymethyl)vinylsilane, and (diethylamino)di(2-ethoxyethyl)vinylsilane; and

cyclic aminodialkylvinylsilane compounds such as 1-pyrrolidinyldimethylvinylsilane, 1-piperidinyldimethylvinylsilane, 1-hexamethyleneiminodimethylvinylsilane, 4,5-dihydro-1-imidazolyldimethylvinylsilane, and morpholinodimethylvinylsilane.

Examples of a compound in which one of X¹, X² and X³ is a substituted amino group and m is 1, of the silicon-containing vinyl compounds represented by the formula (2), include:

(dialkylamino)dialkylvinylphenylsilanes such as (dimethylamino)dimethyl-4-vinylphenylsilane, (dimethylamino)dimethyl-3-vinylphenylsilane, (diethylamino)dimethyl-4-vinylphenylsilane, (diethylamino)dimethyl-3-vinylphenylsilane, (di-n-propylamino)dimethyl-4-vinylphenylsilane, (di-n-propylamino)dimethyl-3-vinylphenylsilane, (di-n-butylamino)dimethyl-4-vinylphenylsilane, (di-n-butylamino)dimethyl-3-vinylphenylsilane, (dimethylamino)diethyl-4-vinylphenylsilane, (dimethylamino)diethyl-3-vinylphenylsilane, (diethylamino)diethyl-4-vinylphenylsilane, (diethylamino)diethyl-3-vinylphenylsilane, (di-n-propylamino)diethyl-4-vinylphenylsilane, (di-n-propylamino)diethyl-3-vinylphenylsilane, (di-n-butylamino)diethyl-4-vinylphenylsilane, and (di-n-butylamino)diethyl-3-vinylphenylsilane.

Examples of a compound in which two of X¹, X² and X³ are a substituted amino group and m is 0, of the silicon-containing vinyl compounds represented by the formula (2), include:

bis(dialkylamino)alkylvinylsilanes such as bis(dimethylamino)methylvinylsilane, bis(diethylamino)methylvinylsilane, bis(di-n-propylamino)methylvinylsilane, bis(di-n-butylamino)methylvinylsilane, bis(dimethylamino)ethylvinylsilane, bis(diethylamino)ethylvinylsilane, bis(di-n-propylamino)ethylvinylsilane, and bis(di-n-butylamino)ethylvinylsilane;

bis[bis(trialkylsilyl)amino]alkylvinylsilanes such as bis[bis(trimethylsilyl)amino]methylvinylsilane, bis[bis(tert-butyldimethyl)amino]methylvinylsilane, bis[bis(trimethylsilyl)amino]ethylvinylsilane, and bis[bis(tert-butyldimethyl)amino]ethylvinylsilane;

bis(dialkylamino)alkoxyalkylvinylsilanes such as bis(dimethylamino)methoxymethylvinylsilane, bis(dimethylamino)(2-methoxyethyl)vinylsilane, bis(dimethylamino)ethoxymethylvinylsilane, bis(dimethylamino)(2 -ethoxyethyl)vinylsilane, bis(diethylamino)methoxymethylvinylsilane, bis(diethylamino)(2-methoxyethyl)vinylsilane, bis(diethylamino)ethoxymethylvinylsilane, and bis(dimethylamino)(2-ethoxyethyl)vinylsilane; and

bis(cyclic amino)alkylvinylsilane compounds such as bis(1-pyrrolidinyl)methylvinylsilane, bis(1-piperidinyl)methylvinylsilane, bis(1-hexamethyleneimino)methylvinylsilane, bis(4,5-dihydro-1-imidazolyl)methylvinylsilane, and bis(morpholino)methylvinylsilane.

Examples of a compound in which two of X¹, X² and X³ are a substituted amino group and m is 1, of the silicon-containing vinyl compounds represented by the formula (2), include:

bis(dialkylamino)alkylvinylphenylsilanes such as bis(dimethylamino)methyl-4-vinylphenylsilane, bis(dimethylamino)methyl-3-vinylphenylsilane, bis(diethylamino)methyl-4-vinylphenylsilane, bis(diethylamino)methyl-3-vinylphenylsilane, bis(di-n-propylamino)methyl-4-vinylphenylsilane, bis(di-n-propylamino)methyl-3-vinylphenylsilane, bis(di-n-butylamino)methyl-4-vinylphenylsilane, bis(di-n-butylamino)methyl-3-vinylphenylsilane, bis(dimethylamino)ethyl-4-vinylphenylsilane, bis(dimethylamino)ethyl-3-vinylphenylsilane, bis(diethylamino)ethyl-4-vinylphenylsilane, bis(diethylamino)ethyl-3-vinylphenylsilane, bis(di-n-propylamino)ethyl-4-vinylphenylsilane, bis(di-n-propylamino)ethyl-3-vinylphenylsilane, bis(di-n-butylamino)ethyl-4-vinylphenylsilane, and bis(di-n-butylamino)ethyl-3-vinylphenylsilane.

Examples of a compound in which three of X¹, X² and X³ are a substituted amino group and m is 0, of the silicon-containing vinyl compounds represented by the formula (2), include:

tris(dialkylamino)vinylsilanes such as tris(dimethylamino)vinylsilane, tris(diethylamino)vinylsilane, tris(di-n-propylamino)vinylsilane, and tris(di-n-butylamino)vinylsilane. Examples of a compound in which three of X¹, X² and X³ are a substituted amino group and m is 1, of the silicon-containing vinyl compounds represented by the formula (2), include:

tris(dialkylamino)vinylphenylsilanes such as tris(dimethylamino)-4-vinylphenylsilane, tris(dimethylamino)-3-vinylphenylsilane, tris(diethylamino)-4-vinylphenylsilane, tris(diethylamino)-3-vinylphenylsilane, tris(di-n-propylamino)-4-vinylphenylsilane, tris(di-n-propylamino)-3-vinylphenylsilane, tris(di-n-butylamino)-4-vinylphenylsilane, and tris(di-n-butylamino)-3-vinylphenylsilane.

Examples of a compound in which X¹, X² and X³ are not a substituted amino group and m is 0, of the silicon-containing vinyl compounds represented by the formula (2), include:

trialkoxyvinylsilanes such as trimethoxyvinylsilane, triethoxyvinylsilane, and tripropoxyvinylsilane; dialkoxyalkylvinylsilanes such as methyldimethoxyvinylsilane and methyldiethoxyvinylsilane; dialkoxyarylvinylsilanes such as di(tert-pentoxy)phenylvinylsilane and di(tert-butoxy)phenylvinylsilane; monoalkoxydialkylvinylsilanes such as dimethylmethoxyvinylsilane; monoalkoxydiarylvinylsilanes such as tert-butoxydiphenylvinylsilane and tert-pentoxydiphenylvinylsilane; monoalkoxyalkylarylvinylsilanes such as tert-butoxymethylphenylvinylsilane and tert-butoxyethylphenylvinylsilane; and substituted alkoxyvinylsilane compounds such as tris(β-methoxyethoxy)vinylsilane.

Further, examples of the silicon-containing vinyl compound include bis(trialkylsilyl)aminostyrenes such as 4-N,N-bis(trimethylsilyl)aminostyrene and 3-N,N-bis(trimethylsilyl)aminostyrene; and bis(trialkylsilyl)aminoalkylstyrenes such as 4-bis(trimethylsilyl)aminomethylstyrene, 3-bis(trimethylsilyl)aminomethylstyrene, 4-[2-bis(trimethylsilyl)aminoethyl]styrene, and 3-[2-bis(trimethylsilyl)aminoethyl]styrene.

The silicon-containing vinyl compound is preferably a compound represented by the formula (2), more preferably a compound in which m in the formula (2) is 0, further preferably a compound in which two of X¹, X² and X³ in the formula (2) are a dialkylamino group, and particularly preferably a compound in which one of X¹, X² and X³ in the formula (2) is an alkyl group.

A compound which is particularly preferable as the silicon-containing vinyl compound is bis(dimethylamino)methylvinylsilane, bis(diethylamino)methylvinylsilane, bis(di-n-propylamino)methylvinylsilane, or bis(di-n-butylamino)methylvinylsilane.

In addition, in a monomer unit based on the compound represented by the formula (2), a group represented by X¹, X² and X³ may be a hydroxyl group through hydrolysis or the like.

In the present invention, in order to enhance fuel cost saving properties, the amount of the silicon-containing vinyl compound used is preferably 0.01 wt % or more, more preferably 0.02 wt % or more, and further preferably 0.05 wt % or more per 100 wt % of the total amount of monomer components used in polymerization. In order to enhance economical properties and to increase tensile strength at break, the amount used is preferably 20 wt % or less, more preferably 2 wt % or less, and further preferably 1 wt % or less.

In the present invention, in order to enhance tensile strength at break, it is preferable that polymerization is performed using an aromatic vinyl compound as a monomer component, in addition to the conjugated diene compound and the silicon-containing vinyl compound. Examples of the aromatic vinyl compound include styrene, a-methylstyrene, vinyltoluene, vinylnaphthalene, divinylbenzene, trivinylbenzene, and divinylnaphthalene, and preferably styrene.

The amount of the aromatic vinyl compound used is 0 wt % or more (the amount of the conjugated diene compound used is 100 wt % or less), preferably 10 wt % or more (the amount of the conjugated diene compound used is 90 wt % or less), and more preferably 15 wt % or more (the content of the conjugated diene compound is 85 wt % or less), per 100 wt % of the total amount of the conjugated diene compound and the aromatic vinyl compound. Further, in order to enhance fuel cost saving properties, the content of the aromatic vinyl compound is preferably 50 wt % or less (the content of the conjugated diene compound is 50 wt % or more), and more preferably 45 wt % or less (the content of the conjugated diene compound is 55 wt % or more).

The compound (I) is an organic alkali metal compound. Examples of the organic alkali metal compound include an organic lithium compound, an organic sodium compound, an organic potassium compound, and an organic cesium compound. Examples of the organic lithium compound include alkyllithium compounds such as methyllithium, ethyllithium, n-propyllithium, isopropyllithium, n-butyllithium, isobutyllithium, sec-butyllithium, tert-butyllithium, n-hexyllithium, and n-octyllithium; alkenyllithium compounds such as vinyllithium, and propenyllithium; aryllithium compounds such as phenyllithium, benzyllithium, tolyllithium, and lithium naphthyride; alkylenedilithium compounds such as tetramethylenedilithium, pentamethylenedilithium, hexamethylenedilithium, and decamethylenedilithium; and lithium naphthalenide and lithium biphenylide. Examples of the organic sodium compound include sodium naphthalenide, and sodium biphenylide. Examples of the organic potassium compound include potassium haphthalenide. The compound (I) is preferably an organic lithium compound, more preferably an alkyllithium compound having 1 to 20 carbon atoms, further preferably n-butyllithium, sec-butyllithium, or tert-butyllithium.

The compound (II) is a compound represented by the following formula (1).

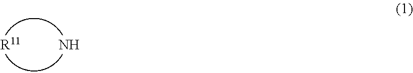

(wherein R¹¹ represents a hydrocarbylene group having 3 to 20 carbon atoms optionally having, as a hetero atom, at least one kind atom selected from an atomic group consisting of a silicon atom, a nitrogen atom and an oxygen atom.)

In the formula (1), the hydrocarbylene group having 3 to 20 carbon atoms optionally having, as a hetero atom, at least one kind atom selected from an atomic group consisting of a silicon atom, a nitrogen atom and an oxygen atom is a hydrocarbylene group having 3 to 20 carbon atoms, or a hetero atom-containing hydrocarbylene group having 3 to 20 carbon atoms in which a hetero atom is at least one kind atom selected from an atomic group consisting of a silicon atom, a nitrogen atom and an oxygen atom. Examples of the hetero atom-containing hydrocarbylene group having 3 to 20 carbon atoms in which a hetero atom is at least one kind atom selected from an atomic group consisting of a silicon atom, a nitrogen atom and an oxygen atom include a hetero atom-containing hydrocarbylene group having 3 to 20 carbon atoms in which a hetero atom is a silicon atom, a hetero atom-containing hydrocarbylene group having 3 to 20 carbon atoms in which a hetero atom is a nitrogen atom, and a hetero atom-containing hydrocarbylene group having 3 to 20 carbon atoms in which a hetero atom is an oxygen atom. Examples of the hydrocarbylene group having 3 to 20 carbon atoms include alkylene groups such as a tetramethylene group, a pentamethylene group, a hexamethylene group, an octamethylene group, a decamethylene group, a dodecamethylene group, a hexane-1,5-diyl group, a 2-methylpentane-1,5-diyl group, a 3-methylpentane-1,5-diyl group, a 2,4-methylpentane-1,5-diyl group, and a 2,2,4-trimethylhexane-1,6-diyl group, and examples of the hetero atom-containing hydrocarbylene group having 3 to 20 carbon atoms in which a hetero atom is a silicon atom include a group represented by —Si(CH₃)₂—CH₂—CH₂—Si(CH₃)₂—. Examples of the hetero atom-containing hydrocarbylene group having 3 to 20 carbon atoms in which a hetero atom is a nitrogen atom include a group represented by —CH═N—CH═CH—, and a group represented by —CH═N—CH₂—CH₂—. Examples of the hetero atom-containing hydrocarbylene group having 3 to 20 carbon atoms in which a hetero atom is an oxygen atom include a group represented by —CH₂—CH₂—O—CH₂—CH₂—.

R¹¹ is preferably a hydrocarbylene group having 3 to 20 carbon atoms, more preferably an alkylene group having 4 to 8 carbon atoms, further preferably a tetramethylene group, a pentamethylene group, or a hexamethylene group.

When R¹¹ is a hydrocarbylene group having 4 carbon atoms, a polymer composition is more excellent in a tensile strength at breakage. The hydrocarbylene group having 4 carbon atoms is preferably an alkylene group having 4 carbon atoms. The compound represented by the formula (1) in which R¹¹ is the alkylene group is pyrrolidine.

And, when R¹¹ is a hydrocarbylene group having 5 to 8 carbon atoms, a polymer composition is more excellent in gripping property. The hydrocarbylene group having 5 to 8 carbon atoms is preferably an alkylene group having 5 to 8 carbon atoms. The compound represented by the formula (1) in which R¹¹ is the alkylene group is preferably piperidine, or hexamethyleneimine.

Examples of a compound in which R¹¹ is a hydrocarbylene group having 3 to 20 carbon atoms, of the compound represented by the formula (1), include trimethyleneimine, pyrrolidine, piperidine, 2-methylpiperidine, hexamethyleneimine, octamethyleneimine, decamethyleneimine, dodecamethyleneimine, 2-methylpiperidine, 3-methylpiperidine, 4-methylpiperidine, 3,5-dimethylpiperidine, 1,2,3,6-tetrahydropyridine, 3,5,5-trimethylhexahydroazepine, and 1,3,3-trimethyl-6-azabicyclo[3,2,2]octane.

Examples of a compound in which R¹¹ is a hetero atom-containing hydrocarbylene group having 3 to 20 carbon atoms, of the compound represented by the formula (1), include 2,2,5,5-tetramethyl-1-aza-2,5-disilacyclopentane as a compound in which a hetero atom is a silicon atom; imidazole, and 4,5-dihydroimidazole as a compound in which a hetero atom is a nitrogen atom; morpholine as a compound in which a hetero atom is an oxygen atom.

Pyrrolidine, piperidine, or hexamethyleneimine is particularly preferable as the compound represented by the formula (1).

In the present invention, the compounds (I) and (II) as a polymerization initiator component are added to a solution containing at least one kind monomer component and using a hydrocarbon as a solvent, in an order of the compound (I) and the compound (II), and a polymer component containing a conjugated diene compound and a silicon-containing vinyl compound is polymerized. Preferably, after the compound (I) is added to the solution, while a polymerization conversion rate of a monomer component is 5 wt % or less, the compound (II) is added to the solution. The polymerization conversion rate is a value letting an amount of a monomer component used in the polymerization in the present process to be 100 wt %.

Examples of a monomer component contained in a solution using a hydrocarbon as a solvent, to which the compound (I) is added, include a conjugated diene compound, a silicon-containing vinyl compound, and an aromatic vinyl compound, preferably a conjugated diene compound.

A concentration of the monomer component in the solution using a hydrocarbon as a solvent is preferably 1 wt % to 50 wt %, more preferably 5 wt % to 30 wt %.

It is preferable that the addition amount of the compound (I) of the present process is 0.01 mmol to 15 mmol per 100 g of the monomer component used in polymerization.

In the present process, the amount of the compound (II) which is added while the polymerization conversion rate of the monomer component is 5 wt % or less is preferably 0.5 mol to 2.0 mol, more preferably 0.8 mol to 1.5 mol based on 1 mol of the addition amount of the compound (I).

After the polymerization conversion rate of the monomer component exceeds 5 wt %, the compound (II) may be added. The addition amount of the compound (II) after the polymerization conversion rate of the monomer component exceeds 5 wt % is preferably 0.5 mol or less based on 1 mol of the addition amount of the compound (I).

After the compound (II) is added to a solution using a hydrocarbon as a solvent, the monomer component may be further added to the solution.

A hydrocarbon used in preparing a solution using the hydrocarbon as a solvent is a compound which does not inactivate the compound (I), and examples thereof include aliphatic hydrocarbons, aromatic hydrocarbons, and alicyclic hydrocarbons. Examples of the aliphatic hydrocarbon include propane, n-butane, iso-butane, n-pentane, iso-pentane, n-hexane, n-heptane, and n-octane. Examples of the aromatic hydrocarbon include benzene, toluene, xylene, and ethylbenzene. Examples of the alicyclic hydrocarbon include cyclopentane and cyclohexane. The hydrocarbon solvent may be a mixture of various components such as industrial hexane. It is preferably a hydrocarbon having 2 to 12 carbon atoms.

The polymerization reaction may be performed in the presence of an agent for adjusting the vinyl bonding amount in a conjugated diene unit, or an agent for adjusting distribution of a conjugated diene unit and a monomer unit based on a monomer other than conjugated diene in a conjugated diene-based polymer chain (hereinafter, collectively referred to as “adjusting agent”). Examples of the agent include ether compounds, tertiary amine compounds, and phosphine compounds. Examples of the ether compound include cyclic ethers such as tetrahydrofuran, tetrahydropyran, and 1,4-dioxane; aliphatic monoethers such as diethyl ether and dibutyl ether; aliphatic diethers such as ethylene glycol dimethyl ether, ethylene glycol diethyl ether, ethylene glycol dibutyl ether, diethylene glycol diethyl ether, and diethylene glycol dibutyl ether; and aromatic ethers such as diphenyl ether and anisole. Examples of the tertiary amine compound include triethylamine, tripropylamine, tributylamine, N,N,N′,N′-tetramethylethylenediamine, N,N-diethylaniline, pyridine, and quinoline. Examples of the phosphine compound include trimethylphosphine, triethylphosphine, and triphenylphosphine. One or more kinds of them are used.

The polymerization temperature in the present invention is usually 25° C. to 100° C., preferably 35° C. to 90° C., and further preferably 50° C. to 80° C. The polymerization time is usually 10 minutes to 5 hours.

In the process for producing a conjugated diene-based polymer of the present invention, a compound containing a nitrogen atom and/or a silicon atom may be reacted with an active end of a polymer produced by polymerization.

Preferable examples of the compound containing a nitrogen atom and/or a silicon atom include compounds containing a nitrogen atom and a carbonyl group.

As the compound containing a nitrogen atom and a carbonyl group, a compound represented by the following formula (3) is preferable.

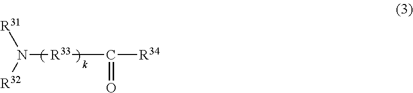

(wherein, R³¹ and R³² may be bonded, or R³¹ and R³¹ may be bonded, R³¹ represents a hydrocarbyl group optionally having a substituent, or is bonded with R³² to represent a hydrocarbylene group optionally having, as a hetero atom, a nitrogen atom and/or an oxygen atom, or is bonded with R³⁴ to represent a divalent group, R³² represents a hydrocarbyl group optionally having a substituent, or is bonded with R³¹ to represent a hydrocarbylene group optionally having, as a hetero atom, a nitrogen atom and/or an oxygen atom, and R³⁴ represents a hydrocarbyl group optionally having a substituent, or a hydrogen atom, or is bonded with R³¹ to represent a divalent group. R³³ represents a divalent group, and k represents 0 or 1.)

In the formula (3), the hydrocarbyl group optionally having a substituent in R³¹, R³² and R³⁴ is a hydrocarbyl group or a substituted hydrocarbyl group. Examples of the substituted hydrocarbyl group include a substituted hydrocarbyl group in which the substituent is a hydrocarbyloxy group, and a substituted hydrocarbyl group in which the substituent is a substituted amino group. Examples of the hydrocarbyl group include alkyl groups such as a methyl group, an ethyl group, a n-propyl group, an isopropyl group, and a n-butyl group; alkenyl groups such as a vinyl group, an allyl group, and an isopropenyl group; and aryl groups such as a phenyl group. Examples of the substituted hydrocarbyl group in which the substituent is a hydrocarbyloxy group include alkoxyalkyl groups such as a methoxymethyl group, an ethoxymethyl group, and an ethyoxyethyl group. Examples of the substituted hydrocarbyl group in which the substituent is a substituted amino group include (N,N-dialkylamino)alkyl groups such as a 2-(N,N-dimethylamino)ethyl group, a 2-(N,N-diethylamino)ethyl group, a 3-(N,N-dimethylamino)propyl group, and a 3-(N,N-diethylamino)propyl group; (N,N-dialkylamino)aryl groups such as a 4-(N,N-dimethylamino)phenyl group, a 3-(N,N-dimethylamino)phenyl group, a 4-(N,N-diethylamino)phenyl group, and a 3-(N,N-diethylamino)phenyl group; (N,N-dialkylamino)alkylaryl groups such as a 4-(N,N-dimethylamino)methylphenyl group and a 4-[2-(N,N-dimethylamino)ethyl]phenyl group; cyclic amino group-containing alkyl groups such as a 3-(1-pyrrolidinyl)propyl group, a 3-(1-piperidinyl)propyl group, and a 3-(1-imidazolyl)propyl group; cyclic amino group-containing aryl groups such as a 4-(1-pyrrolidinyl)phenyl group, a 4-(1-piperidinyl)phenyl group, and a 4-(1-imidazolyl)phenyl group; and cyclic amino group-containing alkylaryl groups such as a 4-[2-(1-pyrrolidinyl)ethyl]phenyl group, a 4-[2-(1-piperidinyl)ethyl]phenyl group, and a 4-[2-(1-imidazolyl)ethyl]phenyl group.

In the formula (3), the hydrocarbylene group optionally having, as a hetero atom, a nitrogen atom and/or an oxygen atom, formed by bonding of R³¹ and R³², is a hydrocarbylene group or a hetero atom-containing hydrocarbylene group in which the hetero atom is a nitrogen atom and/or an oxygen atom. Examples of the hetero atom-containing hydrocarbylene group in which the hetero atom is a nitrogen atom and/or an oxygen atom include a hetero atom-containing hydrocarbylene group in which the hetero atom is a nitrogen atom and a hetero atom-containing hydrocarbylene group in which the hetero atom is an oxygen atom. Examples of the hydrocarbylene group include alkylene groups such as a trimethylene group, a tetramethylene group, a pentamethylene group, a hexamethylene group, and a 2,2,4-trimethylhexane-1,6-diyl group; and arylene groups such as a 1,4-phenylene group. Examples of the hetero atom-containing hydrocarbylene group in which the hetero atom is a nitrogen atom include a group represented by —CH═N—CH═CH— and a group represented by —CH═N—CH₂—CH₂—. Examples of the hetero atom-containing hydrocarbylene group in which the hetero atom is an oxygen atom include a group represented by —(CH₂)ₛ—O—(CH₂)ₜ— (s and t are an integer of 1 or more).

In the formula (3), examples of the divalent group formed by bonding of R³¹ and R³⁴, and the divalent group of R³³ include a hydrocarbylene group, a hetero atom-containing hydrocarbylene group in which the hetero atom is a nitrogen atom, a hetero atom-containing hydrocarbylene group in which the hetero atom is an oxygen atom, a group in which a hydrocarbylene group and an oxygen atom are bonded, and a group in which a hydrocarbylene group and a group represented by —NR³⁵— (R³⁵ represents a hydrocarbyl group or a hydrogen atom) are bonded. Examples of the hydrocarbylene group include alkylene groups such as a trimethylene group, a tetramethylene group, a pentamethylene group, a hexamethylene group, and a 2,2,4-trimethylhexane-1,6-diyl group; and arylene groups such as a 1,4-phenylene group. Examples of the hetero atom-containing hydrocarbylene group in which the hetero atom is a nitrogen atom include a group represented by —CH═N—CH═CH— and a group represented by —CH═N—CH₂—CH₂—. Examples of the hetero atom-containing hydrocarbylene group in which the hetero atom is an oxygen atom include a group represented by —(CH₂)ₛ—O—(CH₂)ₜ— (s and t are an integer of 1 or more). Examples of the group in which a hydrocarbylene group and an oxygen atom are bonded include a group represented by —(CH₂)ᵣ—O— (r represents an integer of 1 or more). Examples of the group in which a hydrocarbylene group and a group represented by —NR³⁵— (R³⁵ represents a hydrocarbyl group or a nitrogen atom) are bonded include a group represented by —(CH₂)ₚ—NR³⁵— (R³⁵ represents a hydrocarbyl group having 1 to 6 carbon atoms, or a hydrogen atom, and p represents an integer of 1 or more).

Examples of a preferable compound represented by the formula (3) include a compound represented by (3-A) in which k is 0 and R³⁴ is a hydrocarbyl group optionally having a substituent or a hydrogen atom.

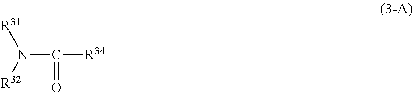

(wherein, R³¹ and R³² may be bonded, R³¹ represents a hydrocarbyl group optionally having a substituent, or is bonded with R³² to represent a hydrocarbylene group optionally having, as a hetero atom, a nitrogen atom and/or an oxygen atom, R³² represents a hydrocarbyl group optionally having a substituent, or is bonded with R³¹ to represent a hydrocarbylene group optionally having, as a hetero atom, a nitrogen atom and/or an oxygen atom, and R³⁴ represents a hydrocarbyl group optionally having a substituent or a hydrogen atom.)

In the formula (3-A), description and exemplification of the hydrocarbyl group optionally having a substituent in R³¹, R³² and R³⁴, and the hydrocarbylene group optionally having, as a hetero atom, a nitrogen atom and/or an oxygen atom, formed by bonding of R³¹ and R³², are the same as those stated in the description of the formula (3).

In the formula (3-A), R³¹ is preferably a hydrocarbyl group having 1 to 10 carbon atoms, or is bonded with R³² to form a hydrocarbylene group having 3 to 10 carbon atoms or a hetero atom-containing hydrocarbylene group having 3 to 10 carbon atoms in which the hetero atom is a nitrogen atom. R³¹ is more preferably an alkyl group having 1 to 10 carbon atoms or an aryl group having 6 to 10 carbon atoms, or is bonded with R³² to form an alkylene group having 3 to 10 carbon atoms, a group represented by —CH═N—CH═CH—, or a group represented by —CH═N—CH₂—CH₂—. R³¹ is further preferably an alkyl group having 1 to 6 carbon atoms. R³¹ is particularly preferably a methyl group or an ethyl group.

In the formula (3-A), R³² is preferably a hydrocarbyl group having 1 to 10 carbon atoms, or is bonded with R³¹ to form a hydrocarbylene group having 3 to 10 carbon atoms or a hetero atom-containing hydrocarbylene group having 3 to 10 carbon atoms in which the hetero atom is a nitrogen atom. R³² is more preferably an alkyl group having 1 to 10 carbon atoms or an aryl group having 6 to 10 carbon atoms, or is bonded with R³¹ to form an alkylene group having 3 to 10 carbon atoms, a group represented by —CH═N—CH═CH—, or a group represented by —CH═N—CH₂—CH₂—. R³² is further preferably an alkyl group having 1 to 6 carbon atoms. R³² is particularly preferably a methyl group or an ethyl group.

In the formula (3-A), R³⁴ is preferably a hydrocarbyl group or a hydrogen atom, more preferably a hydrocarbyl group having 1 to 10 carbon atoms or a hydrogen atom, further preferably an alkyl group having 1 to 6 carbon atoms or a hydrogen atom, and particularly preferably a hydrogen atom, a methyl group or an ethyl group.

Examples of a compound in which R³⁴ is a hydrocarbyl group, of the compounds represented by the formula (3-A), include N,N-dihydrocarbylacetamides such as N,N-dimethylacetamide, N,N-diethylacetamide, and N-methyl-N-ethylacetamide; N,N-dihydrocarbylacrylamides such as N-dimethylacrylamide, N,N-diethylacrylamide, and N-methyl-N-ethylacrylamide; and N,N-dihydrocarbylmethacrylamides such as N,N-dimethylmethacrylamide, N,N-diethylmethacrylamide, and N-methyl-N-ethylmethacrylamide.

Examples of a compound in which R³⁴ is a hydrogen atom, of the compounds represented by the formula (3-A), include N,N-dihydrocarbylformamides such as N,N-dimethylformamide, N,N-diethylformamide, and N-methyl-N-ethylformamide.

Examples of a preferable compound represented by the formula (3) include a compound represented by (3-B) in which k is 0 and R³⁴ is bonded with R³¹ to form a divalent group.

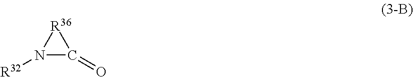

(wherein, R³² represents a hydrocarbyl group optionally having a substituent, R³⁶ represents a group in which a hydrocarbylene group and a group represented by —NR³⁵— are bonded, or a hydrocarbylene group, wherein R³⁵ represents a hydrocarbyl group or a hydrogen atom. A nitrogen atom to which R³⁵ is bonded is bonded with a carbon atom of C═O.)

In the formula (3-B), explanation and exemplification of a hydrocarbyl group optionally having a substituent of R³² are the same as those stated in explanation of the formula (3).

In the formula (3-B), examples of the hydrocarbylene group in R³⁶ include alkylene groups such as a trimethylene group, a tetramethylene group, a pentamethylene group, a hexamethylene group, and a 2,2,4-trimethylhexane-1,6-diyl group; and arylene groups such as a 1,4-phenylene group. Examples of the group in which a hydrocarbylene group and a group represented by —NR³⁵— (R³⁵ represents a hydrocarbyl group or a hydrogen atom) are bonded in R³⁶ include a group represented by —(CH₂)ₚ—NR³⁵— (R³⁵ represents a hydrocarbyl group or a hydrogen atom, and p represents an integer of 1 or more).

In the formula (3-B), R³² is preferably a hydrocarbyl group having 1 to 10 carbon atoms, more preferably an alkyl group having 1 to 10 carbon atoms or an aryl group having 6 to 10 carbon atoms, further preferably an alkyl group having 1 to 6 carbon atoms or a phenyl group, particularly preferably a methyl group, an ethyl group, or a phenyl group.

In the formula (3-B), R³⁶ is preferably a hydrocarbylene group having 1 to 10 carbon atoms, or a group in which a hydrocarbylene group having 1 to 10 carbon atoms and a group represented by —NR³⁵— (R³⁵ represents a hydrocarbyl group having 1 to 10 carbon atoms or a hydrogen atom) are bonded, more preferably an alkylene group having 3 to 6 carbon atoms or a group represented by —(CH₂)ₚ—NR³⁵— (R³⁵ represents a hydrocarbyl group having 1 to 10 carbon atoms, and p represents an integer of 2 to 5), and further preferably a trimethylene group, a tetramethylene group, a pentamethylene group, or a group represented by —(CH₂)₂—N(CH₃)—.

Examples of a compound in which R³⁶ is a hydrocarbylene group, of the compounds represented by the formula (3-B), include N-hydrocarbyl-β-propiolactams such as N-methyl-β-propiolactam and N-phenyl-β-propiolactam; N-hydrocarbyl-2-pyrrolidones such as N-methyl-2-pyrrolidone, N-vinyl-2-pyrrolidone, N-phenyl-2-pyrrolidone, N-tert-butyl-2-pyrrolidone, and N-methyl-5-methyl-2-pyrrolidone; N-hydrocarbyl-2-piperidones such as N-methyl-2-piperidone, N-vinyl-2-piperidone, and N-phenyl-2-piperidone; N-hydrocarbyl-ε-caprolactams such as N-methyl-ε-caprolactam and N-phenyl-ε-caprolactam; N-hydrocarbyl-ω-laurilolactams such as N-methyl-ω-laurilolactam and N-vinyl-ω-laurilolactam. The compound is preferably a compound in which R³⁶ is an alkylene group having 3 to 6 carbon atoms and R³² is an alkyl group having 1 to 6 carbon atoms or a phenyl group, more preferably a compound in which R³⁶ is a trimethylene group, a tetramethylene group, or a pentamethylene group, and R³² is a methyl group, an ethyl group, or a phenyl group, and further preferably N-phenyl-2-pyrrolidone, or N-methyl-ε-caprolactam.

Examples of a compound in which R³⁶ is a group in which a hydrocarbylene group and a group represented by —NR³⁵— (R³⁵ is a hydrocarbyl group or a hydrogen atom) are bonded, of the compounds represented by the formula (3-B), include 1,3-dihydrocarbyl-2-imidazolidinones such as 1,3-dimethyl-2-imidazolidinone, 1,3-diethyl-2-imidazolidinone, 1,3-divinyl-2-imidazolidinone, and 1-methyl-3-ethyl-2-imidazolidinone. The compound is preferably a compound in which R³⁶ is a group represented by —(CH₂)ₚ—NR³⁵— (R³⁵ is a hydrocarbyl group having 1 to 10 carbon atoms, and p represents an integer of 2 to 5) and R³² is an alkyl group having 1 to 6 carbon atoms or a phenyl group, more preferably a compound in which R³⁶ is a group represented by —(CH₂)₂—N(CH₃)— and R³² is a methyl group or an ethyl group, and further preferably 1,3-dimethyl-2-imidazolidinone.

Examples of a preferably compound represented by the formula (3) include a compound represented by the following formula (3-C) in which k is 1 and R³³ is a hydrocarbylene group.

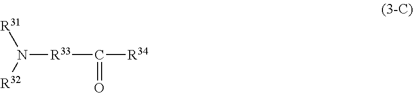

(wherein, R³¹ and R³² may be bonded, R³¹ represents a hydrocarbyl group optionally having a substituent, or is bonded with R³² to represent a hydrocarbylene group optionally having, as a hetero atom, a nitrogen atom and/or an oxygen atom, R³² represents a hydrocarbyl group optionally having a substituent, or is bonded with R³¹ to represent a hydrocarbylene group optionally having, as a hetero atom, a nitrogen atom and/or an oxygen atom, R³³ represents a hydrocarbylene group, and R³⁴ represents a hydrocarbyl group optionally having a substituent.)

In the formula (3-C), description and exemplification of the hydrocarbyl group optionally having a substituent in R³¹, R³² and R³⁴, the hydrocarbylene group optionally having, as a hetero atom, a nitrogen atom and/or an oxygen atom, formed by bonding of R³⁴ and R³², and the hydrocarbylene group in R³³ are the same as those stated in the description of the formula (3).

In the formula (3-C), R³³ is preferably a hydrocarbylene group having 1 to 10 carbon atoms, more preferably an alkylene group having 1 to 10 carbon atoms or an arylene group having 6 to 10 carbon atoms, further preferably an alkylene group having 1 to 6 carbon atoms or a phenylene group, and particularly preferably an ethylene group, a trimethylene group, or a 1,4-phenylene group.

In the formula (3-C), R³⁴ is preferably a hydrocarbyl group having 1 to 10 carbon atoms, or a substituted hydrocarbyl group having 3 to 10 carbon atoms in which the substituent is a dialkylamino group, more preferably an alkyl group having 1 to 6 carbon atoms, an aryl group having 6 to 10 carbon atoms, a dialkylaminoalkyl group having 3 to 6 carbon atoms or a dialkylaminoaryl group having 8 to 10 carbon atoms, and further preferably a methyl group, an ethyl group, a dialkylaminomethyl group having 3 to 6 carbon atoms, a dialkylaminoethyl group having 4 to 6 carbon atoms, a phenyl group, or a dialkylaminophenyl group having 8 to 10 carbon atoms.

In the formula (3-C), R³⁴ is preferably a hydrocarbyl group having 1 to 10 carbon atoms, or is bonded with R³² to form a hydrocarbylene group having 3 to 10 carbon atoms, or a hetero atom-containing hydrocarbylene group having 3 to 10 carbon atoms in which the hetero atom is a nitrogen atom, more preferably an alkyl group having 1 to 10 carbon atoms or an aryl group having 6 to 10 carbon atoms, or is bonded with R³² to form an alkylene group having 3 to 10 carbon atoms, a group represented by —CH═N—CH═CH—, a group represented by —CH═N—CH₂—CH₂—, or a group represented by —(CH₂)₂—O—(CH₂)₂—, further preferably an alkyl group having 1 to 6 carbon atoms, or is bonded with R³² to form an alkylene group having 3 to 6 carbon atoms, a group represented by —CH═N—CH═CH—, or a group represented by —CH═N—CH₂—CH₂—, and particularly preferably a methyl group or an ethyl group, or is bonded with R³² to form a tetramethylene group, a hexamethylene group, or a group represented by —CH═N—CH═CH—.

In the formula (3-C), R³² is preferably a hydrocarbyl group having 1 to 10 carbon atoms, or is bonded with R³¹ to form a hydrocarbylene group having 3 to 10 carbon atoms, or a hetero atom-containing hydrocarbylene group having 3 to 10 carbon atoms in which the hetero atom is a nitrogen atom, more preferably an alkyl group having 1 to 10 carbon atoms or an aryl group having 6 to 10 carbon atoms, or is bonded with R³¹ to form an alkylene group having 3 to 10 carbon atoms, a group represented by —CH═N—CH═CH—, a group represented by —CH═N—CH₂—CH₂—, or a group represented by —(CH₂)₂—O—(CH₂)₂—, further preferably an alkyl group having 1 to 6 carbon atoms, or is bonded with R³¹ to form an alkylene group having 3 to 6 carbon atoms, a group represented by —CH═N—CH═CH—, or a group represented by —CH═N—CH₂—CH₂—, and particularly preferably a methyl group or an ethyl group, or is bonded with R³¹ to form a tetramethylene group, a hexamethylene group, or a group represented by —CH═N—CH═CH—.

Examples of a compound in which R³³ is an arylene group and R³⁴ is an alkyl group, of the compounds represented by the formula (3-C), include 4-(N,N-dihydrocarbylamino)acetophenones such as 4-(N,N-dimethylamino)acetophenone, 4-(N-methyl-N-ethylamino)acetophenone, and 4-(N,N-diethylamino)acetophenone; 4-cyclic amino acetophenone compounds such as 4′-(imidazol-1-yl)acetophenone. Among them, a 4-cyclic amino acetophenone compound is preferable, and 4′-(imidazol-1-yl)acetophenone is more preferable.

Examples of a compound in which R³³ is an arylene group and R³⁴ is an aryl group or a substituted aryl group, of the compounds represented by the formula (3-C), include bis(dihydrocarbylaminoalkyl)ketones such as 1,7-bis(methylethylamino)-4-heptanone and 1,3-bis(diphenylamino)-2-propanone; 4-(dihydrocarbylamino)benzophenones such as 4-N,N-dimethylaminobenzophenone, 4-N,N-diethylaminobenzophenone, 4-N,N-di-t-butylaminobenzophenone, and 4-N,N-diphenylaminobenzophenone; and 4,4′-bis(dihydrocarbylamino)benzphenones such as 4,4′-bis(dimethylamino)benzophenone, 4,4′-bis(diethylamino)benzophenone, and 4,4′-bis(diphenylamino)benzophenone. Among them, a compound in which R³¹ and R³² are an alkyl group having 1 to 6 carbon atoms, R³³ is a phenylene group, and R³⁴ is a phenyl group or a dialkylaminophenyl group having 8 to 10 carbon atoms is preferable, and 4-N,N-dimethylaminobenzophenone, 4-N,N-diethylaminobenzophenone, 4,4′-bis(dimethylamino)benzophenone, and 4,4′-bis(diethylamino)benzophenone are more preferable.

Examples of a preferable compound represented by the formula (3) include a compound represented by the following formula (3-D) in which k is 1 and R³³ is a group in which a hydrocarbylene group and an oxygen atom are bonded, or a group in which a hydrocarbylene group and a group represented by —NR³⁵— (R³⁵ represents a hydrocarbyl group or a hydrogen atom) are bonded.

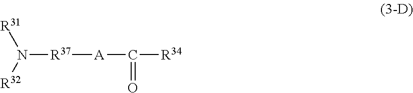

(wherein, R³¹ and R³² may be bonded, R³¹ represents a hydrocarbyl group optionally having a substituent, or is bonded with R³² to represent a hydrocarbylene group optionally having, as a hetero atom, a nitrogen atom and/or an oxygen atom, R³² represents a hydrocarbyl group optionally having a substituent, or is bonded with R³¹ to represent a hydrocarbylene group optionally having, as a hetero atom, a nitrogen atom and/or an oxygen atom, R³⁷ represents a hydrocarbylene group, A represents an oxygen atom or —NR³⁵—, R³⁵ represents a hydrocarbylene group or a hydrogen atom, and R³⁴ represents a hydrocarbyl group optionally having a substituent.)

In the formula (3-D), description and exemplification of the hydrocarbyl group optionally having a substituent in R³¹, R³³ and R³⁴, and the hydrocarbylene group optionally having, as a hetero atom, a nitrogen atom and/or an oxygen atom, formed by bonding of R³¹ and R³², are the same as those stated in the description of the formula (3).

In the formula (3-D), A is preferably an oxygen atom or a group represented by —NR³⁵— (R³⁵ is a hydrocarbylene group having 1 to 5 carbon atoms or a hydrogen atom), more preferably an oxygen atom or a group represented by —NH—, and further preferably a group represented by —NH—.

In the formula (3-D), examples of the hydrocarbylene group in R³⁷ include alkylene groups such as a trimethylene group, a tetramethylene group, a pentamethylene group, a hexamethylene group, and a 2,2,4-trimethylhexane-1,6-diyl group; arylene groups such as a 1,4-phenylene group.

In the formula (3-D), R³⁴ is preferably a hydrocarbyl group having 1 to 10 carbon atoms, more preferably an alkenyl group having 2 to 5 carbon atoms, further preferably a vinyl group or an isopropenyl group, and particularly preferably a vinyl group.

In the formula (3-D), R³⁷ is preferably a hydrocarbylene group having 1 to 10 carbon atoms, more preferably an alkylene group having 1 to 6 carbon atoms, further preferably an ethylene group or a trimethylene group, and particularly preferably a trimethylene group.

In the formula (3-D), R³¹ is preferably a hydrocarbyl group having 1 to 10 carbon atoms, or is bonded with R³² to form a hydrocarbylene group having 3 to 10 carbon atoms, or a hetero atom-containing hydrocarbylene group having 3 to 10 carbon atoms in which the hetero atom is a nitrogen atom, more preferably an alkyl group having 1 to 10 carbon atoms or an aryl group having 6 to 10 carbon atoms, or is bonded with R³² to form an alkylene group having 3 to 10 carbon atoms, a group represented by —CH═N—CH═CH—, a group represented by —CH═N—CH₂—CH₂—, or a group represented by —(CH₂)₂—O—(CH₂)₂—, further preferably an alkyl group having 1 to 6 carbon atoms, or is bonded with R³² to form an alkylene group having 3 to 6 carbon atoms, a group represented by —CH═N—CH═CH—, or a group represented by —CH═N—CH₂—CH₂—, and particularly preferably a methyl group or an ethyl group, or is bonded with R³² to form a tetramethylene group, a hexamethylene group, or a group represented by —CH═N—CH═CH—.

In the formula (3-D), R³² is preferably a hydrocarbyl group having 1 to 10 carbon atoms, or is bonded with R³¹ to form a hydrocrbylene group having 3 to 10 carbon atoms, or a hetero atom-containing hydrocarbylene group having 3 to 10 carbon atoms in which the hetero atom is a nitrogen atom, more preferably an alkyl group having 1 to 10 carbon atoms or an aryl group having 6 to 10 carbon atoms, or is bonded with R³¹ to form an alkylene group having 3 to 10 carbon atoms, a group represented by —CH═N—CH═CH—, a group represented by —CH═N—CH₂—CH₂—, or a group represented by —(CH₂)₂—O—(CH₂)₂—, further preferably an alkyl group having 1 to 6 carbon atoms, or is bonded with R³¹ to form an alkylene group having 3 to 6 carbon atoms, a group represented by —CH═N—CH═CH—, or a group represented by —CH═N—CH₂—CH₂—, and particularly preferably a methyl group or an ethyl group, or is bonded with R³¹ to form a tetramethylene group, a hexamethylene group, or a group represented by —CH═N—CH═CH—.

Examples of a compound in which A is an oxygen atom, of the compounds represented by the formula (3-D), include:

2-(dihydrocarbylamino)ethyl acrylates such as 2-(dimethylamino)ethyl acrylate and 2-(diethylamino)ethyl acrylate; 3-(dihydrocarbylamino)propyl acrylates such as 3-(dimethylamino)propyl acrylate; 2-(dihydrocarbylamino)ethyl methacrylates such as 2-(dimethylamino)ethyl methacrylate and 2-(diethylamino)ethyl methacrylate; 3-(dihydrocarbylamino)propyl methacrylates such as 3-(dimethylamino)propyl methacrylate. As the compound in which A is an oxygen atom, a compound in which R³¹ and R³² are an alkyl group having 1 to 6 carbon atoms, R³⁴ is a vinyl group or an isopropenyl group, and R³⁷ is an ethylene group or a trimethylene group is preferable, and a compound in which R³¹ and R³² are a methyl group or an ethyl group, R³⁴ is a vinyl group, and R³⁷ is a trimethylene group is more preferable.

Examples of a compound in which A is a group represented by —NR³⁵— (R³⁵ is a hydrocarbylene group or a hydrogen atom), of the compounds represented by the formula (3-D), include:

N-(2-dihydrocarbylaminoethyl)acrylamides such as N-(2-dimethylaminoethyl)acrylamide and N-(2-diethylaminoethyl)acrylamide; N-(3-dihydrocarbylaminopropyl)acrylamides such as N-(3-dimethylaminopropyl)acrylamide and N-(3-diethylaminopropyl)acrylamide; N-(4-dihydrocarbylaminobutyl)acrylamides such as N-(4-dimethylaminobutyl)acrylamide and N-(4-diethylaminobutyl)acrylamide; N-(2-dihydrocarbylaminoethyl)methacrylamides such as N-(2-dimethylaminoethyl)methacrylamide and N-(2-diethylaminoethyl)methacrylamide; N-(3-dihydrocarbylaminopropyl)methacrylamides such as N-(3-dimethylaminopropyl)methacrylamide and N-(3-diethylaminopropyl)methacrylamide; N-(4-dihydrocarbylaminobutyl)methacrylamides such as N-(4-dimethylaminobutyl)methacrylamide and N-(4-diethylaminobutyl)methacrylamide. Among them, a compound in which A is a group represented by —NH—, R³¹ and R³² are an alkyl group having 1 to 6 carbon atoms, R³⁴ is a vinyl group or an isopropenyl group, and R³⁷ is an ethylene group or a trimethylene group is preferable, and a compound in which A is a group represented by —NH—, R³⁴ and R³² are a methyl group or a methyl group, R³⁴ is a vinyl group, and R³⁷ is a trimethyene group is more preferable.

Examples of the compound containing a nitrogen atom and/or a silicon atom include also a compound containing an alkoxysilyl group, in addition to the aforementioned compounds.

Examples of the compound having an alkoxysilyl group include: tetraalkoxysilanes such as tetramethoxysilane, tetraethoxysilane, and tetra-n-propoxysilane; trialkoxyhydrocarbylsilanes such as methyltrimethoxysilane, methyltriethoxysilane, ethyltrimethoxysilane, and phenyltrimethoxysilane; trialkoxyhalosilanes such as trimethoxychlorosilane, triethoxychlorosilane, and tri-n-propoxychlorosilane; dialkoxydihydrocarbylsilanes such as dimethoxydimethylsilane, diethoxydimethylsilane, and dimethoxydiethylsilane; dialkoxydihalosilanes such as dimethoxydichlorosilane, diethoxydichlorosilane, and di-n-propoxydichlorosilane; monoalkoxytrihydrocarbylsilanes such as methoxytrimethylsilane; monoalkoxytrihalosilanes such as methoxytrichlorosilane, and ethoxytrichlorosilane; (glycidoxyalkyl)alkylalkoxysilane compounds such as 2-glycidoxyethyltrimethoxysilane, 2-glycidoxyethyltriethoxysilane, (2-glycidoxyethyl)methyldimethoxysilane, 3-glycidoxypropyltrimethoxysilane, 3-glycidoxypropyltriethoxysilane, and (3-glycidoxypropyl)methyldimethoxysilane; (3,4-epoxycyclohexyl)alkylalkoxysilane compounds such as 2-(3,4-epoxycyclohexyl)ethyltrimethoxysilane, and 2-(3,4-epoxycyclohexyl)ethyltriethoxysilane; [(3,4-epoxycyclohexyl)alkyl]alkylalkoxysilane compounds such as [2-(3,4-epoxycyclohexyl)ethyl]methyldimethoxysilane; alkoxysilylalkylsuccinic acid anhydrides such as 3-trimethoxysilylpropylsuccinic acid anhydride, and 3-triethoxysilylpropylsuccinic acid anhydride; (methacryloyloxyalkyl)alkoxysilane compounds such as 3-methacryloyloxypropyltrimethoxysilane, and 3-methacryloyloxypropyltriethoxysilane; [(dialkylamino)alkyl]alkoxysilane compounds such as [3-(dimethylamino)propyl]trimethoxysilane, [3-(diethylamino)propyl]triethoxysilane, [3-(diethylamino)propyl]trimethoxysilane, [3-(dimethylamino)propyl]methyldiethoxysilane, [2-(dimethylamino)ethyl]triethoxysilane, [2-(dimethylamino)ethyl]trimethoxysilane; cyclic aminoalkylalkoxysilane compounds such as (1-hexamethyleneiminomethyl)trimethoxysilane, [3-(1-hexamethyleneimino)propyl]triethoxysilane, N-(3-triethoxysilylpropyl)-4,5-dihydroimidazole, N-(3-trimethoxysilylpropyl)-4,5-imidazole; {[di(tetrahydrofuranyl)amino]alkyl}alkoxysilane compounds such as {3-[di(tetrahydrofuranyl)amino]propyl}trimethoxysilane, {3-[di(tetrahydrofuranyl)amino]propyl}triethoxysilane; [N,N-bis(trialkylsilyl)aminoalkyl]alkylalkoxysilane compounds such as {3-[N,N-bis(trimethylsilyl)amino]propyl}methyldimethoxysilane, {3-[N,N-bis(trimethylsilyl)amino]propyl}methyldiethoxysilane. As the [(dialkylamino)alkyl]alkoxysilane compound, [3-(dialkylamino)propyl]alkoxysilane in which an alkyl group of a dialkylamino group is an alkyl group having 1 to 4 carbon atoms, and an alkoxy group is an alkoxy group having 1 to 4 carbon atoms is preferable.

The compound containing an alkoxysilyl group may contain a nitrogen atom and a group represented by >C═O. Examples of the compound containing an alkoxysilyl group, and containing a nitrogen atom and a group represented by >C═O include tris[(alkoxysilyl)alkyl]isocyanurate compounds such as tris[3-(trimethoxysilyl)propyl]isocyanurate, tris[3-(triethoxysilyl)propyl]isocyanurate, tris[3-(tripropoxysilyl)propyl]isocyanurate, and tris[3-(tributoxysilyl)propyl]isocyanurate. Among them, tris[3-(trialkoxysilyl)propyl]isocyanurate is preferable, tris[3-(trialkoxysilyl)propyl]isocyanurate in which the alkoxy group is an alkoxy group having 1 to 4 carbon atoms is more preferable, and tris[3-(trimethoxysilyl)propyl]isocyanurate is further preferable.

A reaction of an active end of a polymer produced by adding the following compounds (I) and (II) to a monomer component in an order of the compound (I) and the compound the (II), and polymerizing the monomer component (it is thought that an active end of the polymer has an alkali metal derived from an organic alkali metal compound of the compound (I)), and the compound containing a nitrogen atom and/or silicon atom is performed by adding the compound containing a nitrogen atom and/or a silicon atom to a polymerization solution, and mixing a polymer and the compound containing a nitrogen atom and/or a silicon atom in the solution. The amount of the compound containing the nitrogen atom and/or a silicon atom to be added to the polymerization solution is usually 0.1 mole to 3 mole, preferably 0.5 mole to 2 mole, and more preferably 0.7 mole to 1.5 mole per 1 mole of the organic alkali metal compound of the compound (I).

A temperature at which a polymer and the compound containing a nitrogen atom and/or a silicon atom are mixed is 25° C. to 100° C., preferably 35° C. to 90° C., and more preferably 50° C. to 80° C. The contact time is 60 seconds to 5 hours and preferably 5 minutes to 1 hour.

In the production process of the present invention, a coupling agent may be added to a solution containing a conjugated diene-based polymer using a hydrocarbon as a solvent, from initiation of polymerization of a monomer to recovery of a polymer described later. Examples of the coupling agent include a compound represented by the following formula (4).

R^{41a}ML₄₋ₐ (4)

(wherein, R⁴¹ represents an alkyl group, an alkenyl group, a cycloalkenyl group or an aryl group, M represents a silicon atom or a tin atom, L represents a halogen atom or a hydrocarbyloxy group, and a represents an integer of 0 to 2.)

Examples of the coupling agent represented by the formula (4) include silicon tetrachloride, methyltrichlorosilane, dimethyldichlorosilane, trimethylchlorosilane, tin tetrachloride, methyltrichlorotin, dimethyldichlorotin, trimethylchlorotin, tetramethoxysilane, methyltrimethoxysilane, dimethoxydimethylsilane, methyltriethoxysilane, ethyltrimethoxysilane, dimethoxydiethylsilane, diethoxydimethylsilane, tetraethoxysilane, ethyltriethoxysilane, and diethoxydiethylsilane.

In order to enhance processibility of the conjugated diene-based polymer, the amount of the coupling agent used is preferably 0.03 mol or more, and more preferably 0.05 mol or more, per 1 mol of the alkali metal derived from an alkali metal catalyst. In order to enhance fuel cost saving properties, the amount is preferably 0.4 mol or less, and more preferably 0.3 mol or less.

In the production process of the present invention, an unreacted active end may be treated with an alcohol such as methanol or isopropyl alcohol before recovery of a polymer described later.

As a method of recovering a conjugated diene-based polymer from a solution containing a conjugated diene-based polymer using a hydrocarbon as a solvent, known methods can be used, and examples thereof include (A) a method of adding a coagulant to a solution containing a conjugated diene-based polymer and (B) a method of adding steam to a solution containing a conjugated diene-based polymer. The recovered conjugated diene-based polymer may be dried with a known dryer such as a band dryer or an extrusion-type dryer.

The conjugated-diene-based polymer of the present invention is a conjugated diene-based polymer produced by the aforementioned process.

In order to enhance tensile strength at break, the Mooney viscosity (ML₁₊₄) of the conjugated diene-based polymer of the present invention is preferably 10 or more, and more preferably 20 or more. Further, in order to enhance processibility, the Mooney viscosity is preferably 200 or less, and more preferably 150 or less. The Mooney viscosity (ML₁₊₄) is measured at 100° C. according to JIS K6300 (1994).

In order to enhance fuel cost saving properties, the molecular weight distribution of the conjugated diene-based polymer of the present invention is preferably 1 to 5, and more preferably 1 to 2. A molecular weight distribution is obtained by measuring a number average molecular weight (Mn) and a weight average molecular weight (Mw) by a gel permeation chromatography (GPC) method, and dividing Mw with Mn.

In order to enhance fuel cost saving properties, the content of a monomer unit based on a silicon-containing vinyl compound is preferably 0.01 wt % or more, more preferably 0.02 wt % or more, and further preferably 0.05 wt % or more, per 100 wt % of the conjugated diene-based polymer. In order to enhance economical properties and to increase tensile strength at break, the content is preferably 20 wt % or less, more preferably 2 wt % or less, and further preferably 1 wt % or less.

In order to enhance tensile strength at break, it is preferable that the conjugated diene-based polymer of the present invention contains a monomer unit based on an aromatic vinyl compound, in addition to the monomer unit based on a conjugated diene compound and the monomer unit based on a silicon-containing vinyl compound. Examples of the aromatic vinyl compound include styrene, a-methylstyrene, vinyltoluene, vinylnaphthalene, divinylbenzene, trivinylbenzene, and divinylnaphthalene, and preferably styrene.

The content of the aromatic vinyl compound unit is 0 wt % or more (the content of the conjugated diene compound unit is 100 wt % or less), preferably 10 wt % or more (the content of the conjugated diene compound unit is 90 wt % or less), and more preferably 15 wt % or more (the content of the conjugated diene compound unit is 85 wt % or less), per 100 wt % of the total amount of the conjugated diene compound unit and the aromatic vinyl compound unit. In order to enhance fuel cost saving properties, the content of the aromatic vinyl compound unit is preferably 50 wt % or less (the content of the conjugated diene compound unit is 50 wt % or more), and more preferably 45 wt % or less (the content of the conjugated diene compound unit is 55 wt % or more).

In order to enhance fuel cost saving properties, the vinyl bonding amount in the conjugated diene-based polymer of the present invention is preferably 80 mol % or less, and more preferably 70 mol % or less, per 100 mol% of the content of the conjugated diene unit. In order to enhance gripping properties, the vinyl bonding amount is preferably 10 mol % or more, more preferably 15 mol % or more, further preferably 20 mol % or more, and particularly preferably 40 mol % or more. The vinyl bonding amount is obtained from the absorption intensity around 910 cm⁻¹, which is the absorption peak of a vinyl group, by an infrared spectrometric method.

The conjugated diene-based polymer of the present invention can be used as a conjugated diene-based polymer composition by incorporating other polymer components and additives.

Examples of the other polymer component include styrene-butadiene copolymer rubber, polybutadiene rubber, butadiene-isoprene copolymer rubber, and butyl rubber. Examples thereof also include natural rubber, an ethylene-propylene copolymer, and an ethyelene-octene copolymer. One or more kinds of these polymer components are used.

When the other polymer components are incorporated into the conjugated diene-based polymer of the present invention, in order to enhance fuel cost saving properties, the amount of the conjugated diene-based polymer of the present invention incorporated is preferably 10 wt % or more, and more preferably 20 wt % or more, per 100 wt % of the total amount of the polymer components incorporated (including the amount of the conjugated diene-based polymer incorporated).

As the additives, known additives can be used, and examples thereof include vulcanization agents such as sulfur; vulcanization accelerators such as a thiazole-based vulcanization accelerator, a thiuram-based vulcanization accelerator, a sulfenamide-based vulcanization accelerator, and a guanidine-based vulcanization accelerator; vulcanization activating agents such as stearic acid and zinc oxide; organic peroxides such as dicumyl peroxide and ditertiarybutyl peroxide; reinforcing agents such as silica and carbon black; fillers such as calcium carbonate, talc, alumina, clay, aluminum hydroxide, and mica; silane coupling agents; extender oils; processing aids; anti-aging agents; and lubricants.

Examples of the sulfur include powder sulfur, precipitated sulfur, colloidal sulfur, insoluble sulfur, and highly dispersible sulfur. The amount of the sulfur incorporated is preferably 0.1 parts by weight to 15 parts by weight, more preferably 0.3 parts by weight to 10 parts by weight, and further preferably 0.5 parts by weight to 5 parts by weight, per 100 parts by weight of the polymer component.

Examples of the vulcanization accelerator include thiazole-based vulcanization accelerators such as 2-mercaptobenzothiazole, dibenzothiazyl disulfide, and N-cyclohexyl-2-benzothiazylsulfenamide; thiuram-based vulcanization accelerators such as tetramethylthiuram monosulfide and tetramethylthiuram disulfide; sulfenamide-based vulcanization accelerators such as N-cyclohexyl-2-benzothiazolesulfenamide, N-tert-butyl-2-benzothiazolesulfenamide, N-oxyethylene-2-benzothiazolesulfenamide, N-oxyethylene-2-benzothiazolesulfenamide, and N,N′-diisopropyl-2-benzothiazolesulfenamide; guanidine-based vulcanization accelerators such as diphenylguanidine, diorthotolylguanidine, and orthotolylbiguanidine. The amount of the vulcanization accelerator incorporated is preferably 0.1 parts by weight to 5 parts by weight, and more preferably 0.2 parts by weight to 3 parts by weight, per 100 parts by weight of the polymer component.

Examples of the silica include dry silica (silicic acid anhydride), wet silica (hydrous silicic acid), colloidal silica, precipitated silica, calcium silicate, and aluminum silicate. One or more kinds of them can be used. The BET specific surface area of silica is preferably 50 m²/g to 250 m²/g. The BET specific surface area is measured according to ASTM D1993-03. As commercially available products, trade name Ultrasil VN3-G, manufactured by Degussa, trade name VN3, AQ, ER, and RS-150, manufactured by Tosoh Silica Corporation, and trade name Zeosil 1115MP, 1165MP, manufactured by Rhodia, and the like can be used.

Examples of the carbon black include furnace black, acetylene black, thermal black, channel black, and graphite. Examples of the carbon black include channel carbon black such as EPC, MPC and CC; furnace carbon black such as SAF, ISAF, HAF, MAF, FEF, SRF, GPF, APF, FF, CF, SCF and ECF; thermal carbon black such as FT and MT; and acetylene carbon black. One or more kinds of them can be used.

The nitrogen adsorption specific surface area (N₂SA) of carbon black is preferably 5 m²/g to 200 m²/g, and the dibutyl phthalate (DBP) absorption amount of carbon black is preferably 5 ml/100 g to 300 ml/100 g. The nitrogen adsorption specific surface area is measured according to ASTM D4820-93. The DBP absorption amount is measured according to ASTM D2414-93. As commercially available products, Dia black N339, manufactured by Mitsubishi Chemical Corporation, trade name SEAST 6, SEAST 7HM, and SEAST KH, manufactured by Tokai Carbon Co., Ltd., trade name CK 3, Special Black 4A, manufactured by Degussa, and the like can be used.

When formulated into a conjugated diene-based polymer composition in which a reinforcing agent is incorporated into the conjugated diene-based polymer of the present invention, the amount of the reinforcing agent incorporated is preferably 10 parts by weight to 150 parts by weight, per 100 parts by weight of the amount of the conjugated diene-based polymer of the present invention incorporated. In order to enhance abrasion resistance and strength, the amount incorporated is more preferably 20 parts by weight or more, and further preferably 30 parts by weight or more. In order to enhance reinforcing properties, the amount incorporated is more preferably 120 parts by weight or less, and further preferably 100 parts by weight or less.

In order to enhance fuel cost saving properties, when formulated into a conjugated diene-based polymer composition in which a reinforcing agent is incorporated into the conjugated diene-based polymer of the present invention, it is preferable to use silica as the reinforcing agent. The amount of silica incorporated is preferably 50 parts by weight or more, and more preferably 70 parts by weight or more, per 100 parts by weight of the total amount of the reinforcing agent incorporated.

The weight ratio of the content of silica used as the reinforcing agent and the content of carbon black (the content of silica the content of carbon black) is preferably 2:1 to 50:1. In order to enhance fuel cost saving properties and reinforcing properties, the weight ratio is more preferably 5:1 to 20:1.

Examples of the silane coupling agent include vinyltrichlorosilane, vinyltriethoxysilane, vinyltris(β-methoxyethoxy)silane, β-(3,4-epoxycyclohexyl)ethyltrimethoxysilane, γ-glycidoxypropyltrimethoxysilane, γ-methacryloxypropyltrimethoxysilane, N-(β-aminoethyl)-γ-aminopropyltrimethoxysilane, N-(β-aminoethyl)-γ-aminopropylmethyldimethoxysilane, N-phenyl-γ-aminopropyltrimethoxysilane, γ-chloropropyltrimethoxysilane, γ-mercaptopropyltrimethoxysilane, γ-aminopropyltriethoxysilane, bis(3-(triethoxysilyl)propyl) disulfide, bis(3-(triethoxysilyl)propyl) tetrasulfide, γ-trimethoxysilylpropyldimethylthiocarbamyl tetrasulfide, and γ-trimethoxysilylpropylbenzothiazyl tetrasulfide. One or more kinds of them are used. As commercially available products, trade name Si69, Si75, manufactured by Degussa and the like can be used.

When formulated into a conjugated diene-based polymer composition in which a silane coupling agent is incorporated into the conjugated diene-based polymer of the present invention, the amount of the silane coupling agent incorporated is preferably 1 part by weight to 20 parts by weight, more preferably 2 parts by weight to 15 parts by weight, and further preferably 5 parts by weight to 10 parts by weight, per 100 parts by weight of the silica.

Examples of the extender oil include aromatic-based mineral oils (viscosity gravity constant (V.G.C. value) 0.900 to 1.049), naphthene-based mineral oils (V.G.C. value 0.850 to 0.899), and paraffin-based mineral oils (V.G.C. value 0.790 to 0.849). The content of polycyclic aromatic compound in the extender oil is preferably less than 3 wt %, and more preferably less than 1 wt %. The polycyclic aromatic content is measured according to the British Institute of Petroleum 346/92 Method. The content of aromatic compound (CA) in the extender oil is preferably 20 wt % or more. One or more kinds of these extender oils are used.

As a method for producing a conjugated diene-based polymer composition by incorporating other polymer components and additives into the conjugated diene-based polymer of the present invention, known methods, for example, a method of kneading each component with a known mixer such as a roll mixer or Banbury mixer can be used.

As kneading condition, when additives other than the vulcanization agent and the vulcanization accelerator are incorporated, the kneading temperature is usually 50° C. to 200° C., and preferably 80° C. to 190° C., and the kneading time is usually 30 seconds to 30 minutes, preferably 1 minute to 30 minutes. When the vulcanization agent and the vulcanization accelerator are incorporated, the kneading temperature is usually 100° C. or lower, preferably room temperature to 80° C. A composition in which the vulcanization agent and the vulcanization accelerator are incorporated is usually subjected to vulcanization treatment such as press vulcanization for use. The vulcanizing temperature is usually 120 to 200° C., and preferably 140 to 180° C.

The conjugated diene-based polymer composition of the present invention is excellent in cost saving properties, and is also good in a tensile strength at breakage and gripping property. The conjugated diene-based polymer composition of the present invention is suitably used in tires.

### EXAMPLES

The evaluation of physical properties was performed by the following methods.

### 1. Mooney Viscosity (ML₁₊₄)

According to JIS K6300 (1994), the Mooney viscosity of a polymer was measured at 100° C.

2. Vinyl Bonding Amount (unit: mol %)

The vinyl bonding amount of a polymer was obtained from the absorption intensity around 910 cm⁻¹, which is an absorption peak of a vinyl group, by an infrared spectrometric method.

3. Content of Styrene Unit (unit: wt %)

According to JIS K6383 (1995), the content of a styrene unit in a polymer was obtained from a refractive index.

### 4. Molecular Weight Distribution (Mw/Mn)

A weight average molecular weight (Mw) and a number average molecular weight (Mn) were measured under the following conditions (1) to (8) by a gel permeation chromatography (GPC) method, and the molecular weight distribution (Mw/Mn) of a polymer was obtained.
(1) Apparatus: HLC-8220, manufactured by Tosoh Corporation
(2) Separation column: TSKgel SuperHM-H (two in series), manufactured by Tosoh Corporation
(3) Measuring temperature: 40° C.
(4) Carrier: tetrahydrofuran
(5) Flow rate: 0.6 mL/minute
(6) Injection amount: 5 μL
(7) Detector: differential refraction
(8) Molecular weight standard: standard polystyrene

### 5. Fuel Cost Saving Properties

A strip-like test piece having a width of 1 mm or 2 mm and a length of 40 mm was punched out from a sheet-like vulcanization molded article, and was subjected to a test. For measurement, loss tangent (tan δ (70° C.)) of a test piece at a temperature of 70° C. was measured with a viscoelasticity measuring apparatus (manufactured by Ueshima Seisakusho Co., Ltd.) under the conditions of a strain of 1% and a frequency of 10 Hz. As this value is smaller, fuel cost saving properties are more excellent.

### 6. Gripping Property

A strip-like test piece having a width of 1 mm or 2 mm and a length of 40 mm was punched out from a sheet-like vulcanization molded article, and was subjected to a test. For measurement, loss tangent (tan δ (0° C.)) of a test piece at a temperature of 0° C. was measured with a viscoelasticity measuring apparatus (manufactured by Ueshima Seisakusho Co., Ltd.) under the conditions of a strain of 2.5% and a frequency of 10 Hz. As this value is greater, gripping property is more excellent.

### 7. Tensile Strength at Break (TB, Unit: MPa)

According to JIS K6251, a stress at which the test piece is broken was measured at a tensile rate of 500 mm/minute. using a No. 3 shape dumbbell test piece.

### Example 1

The interior of a polymerization reactor made of stainless steel, equipped with a stirring device, and having an internal volume of 20 L was washed and dried, and replaced with dry nitrogen. Then, 10.2 kg of industrial hexane (density 680 kg/m³), 608 g of 1,3-butadiene, 192 g of styrene, 6.1 ml of tetrahydrofuran, and 5.0 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was placed into the polymerization reactor.

Into the polymerization reactor was placed 2.74 g of bis(diethylamino)methylvinylsilane. Then, a solution of n-butyllithium in n-hexane (content of n-butyllithium: 15.4 mmol) as a polymerization initiator component was placed into the polymerization reactor, thereafter, 1.09 g of pyrrolidine (1.01 mol per 1 mol of n-butyllithium) was immediately placed into the polymerization reactor, and a polymerization reaction was initiated. The copolymerization reaction of 1,3-butadiene, styrene and bis(diethylamino)methylvinylsilane was performed for 3 hours at a stirring rate of 130 rpm and a temperature in the polymerization reactor of 65° C., while 1,3-butadiene and styrene were continuously supplied into the polymerization reactor. The amounts of 1,3-butadiene and styrene supplied after initiation of the polymerization reaction were 912 g and 288 g, respectively. The amount of bis(diethylamino)methylvinylsilane placed was 0.14 wt % in the total amount of monomers which had been placed or supplied into the polymerization reactor.

To the polymer solution was added 20 ml of a hexane solution containing 1.2 ml of methanol, and the polymer solution was stirred for 5 minutes. Then, to the polymer solution were added 8.0 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.) and 4.0 g of pentaerythrityltetrakis(3-laurylthiopropionate) (trade name: Sumilizer TP-D, manufactured by Sumitomo Chemical Co., Ltd.). Then, the polymer solution was allowed to stand under ambient temperature for 24 hours, and the solvent was evaporated to obtain a polymer. Thereafter, the resulting polymer was further dried at 55° C. for 12 hours under reduced pressure. The evaluation results of the polymer are shown in Table 1.

One hundred parts by weight of the resulting polymer, 78.4 parts by weight of silica (trade name: Ultrasil VN3-G, manufactured by Degussa), 6.4 parts by weight of a silane coupling agent (trade name: Si69, manufactured by Degussa), 6.4 parts by weight of carbon black (trade name: Diablack N339, manufactured by Mitsubishi Chemical Corporation), 47.6 parts by weight of an extender oil (trade name: JOMO Process NC-140, manufactured by Japan Energy Corporation), 1.5 parts by weight of an anti-aging agent (trade name: Antigen 3C, manufactured by Sumitomo Chemical Co., Ltd.), 2 parts by weight of stearic acid, 2 parts by weight of zinc flower, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes for vulcanization to prepare a vulcanized sheet. The evaluation results of physical properties of the vulcanized sheet are shown in Table 1.

### Example 2

The interior of a polymerization reactor made of stainless steel, equipped with a stirring device, and having an internal volume of 30 L was washed and dried, and replaced with dry nitrogen. Then, 15.3 kg of industrial hexane (density 680 kg/m³), 912 g of 1,3-butadiene, 288 g of styrene, 9.1 ml of tetrahydrofuran, and 7.8 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was placed into the polymerization reactor.

Into the polymerization reactor was placed 4.12 g of bis(diethylamino)methylvinylsilane. Thereafter, a solution of n-butyllithium in n-hexane (content of n-butyllithium: 23.1 mmol) as a polymerization initiator component was placed into the polymerization reactor, thereafter, 2.29 g of (1.01 mol per 1 mol of n-butyllithium) of hexamethyleneimine was immediately placed into the polymerization reactor, and a polymerization reaction was initiated. The copolymerization reaction of 1,3-butadiene, styrene and bis(diethylamino)methylvinylsilane was performed for 3 hours at a stirring rate of 130 rpm and a temperature in the polymerization reactor of 65° C., while 1,3-butadiene and styrene were continuously supplied into the polymerization reactor. The amounts of 1,3-butadiene and styrene supplied after initiation of the polymerization reaction were 1368 g and 432 g, respectively. The amount of bis(diethylamino)methylvinylislane placed was 0.14 wt % in the total amount of monomers which had been placed or supplied into the polymerization reactor.

To the polymer solution was added 20 ml of a hexane solution containing 1.5 ml of methanol, and the polymer solution was stirred for 5 minutes. Then, to the polymer solution were added 12.0 g of 2-tert-butyl-6-(3-tert-butyl-2-hydroxy-5-methylbenzyl)-4-methylphenyl acrylate (trade name: Sumilizer GM, manufactured by Sumitomo Chemical Co., Ltd.) and 6.0 g of pentaerythrityltetrakis(3-laurylthiopropionate) (trade name: Sumilizer TP-D, manufactured by Sumitomo Chemical Co., Ltd.), and the polymer solution was then allowed to stand under ambient temperature for 24 hours, and the solvent was evaporated to obtain a polymer. Thereafter, the resulting polymer was further dried at 55° C. for 12 hours under reduced pressure. The evaluation results of the polymer are shown in Table 1.

One hundred parts by weight of the resulting polymer, 78.4 parts by weight of silica (trade name: Ultrasil VN3-G, manufactured by Degussa), 6.4 parts by weight of a silane coupling agent (trade name: Si69, manufactured by Degussa), 6.4 parts by weight of carbon black (trade name: Diablack N339, manufactured by Mitsubishi Chemical Corporation), 47.6 parts by weight of an extender oil (trade name: JOMO Process NC-140, manufactured by Japan Energy Corporation), 1.5 parts by weight of an anti-aging agent (trade name: Antigen 3C, manufactured by Sumitomo Chemical Co., Ltd.), 2 parts by weight of stearic acid, 2 parts by weight of zinc flower, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes for vulcanization to prepare a vulcanized sheet. The evaluation results of physical properties of the vulcanized sheet are shown in Table 1.

### Comparative Example 1

The interior of a polymerization reactor made of stainless steel, equipped with a stirring device, and having an internal volume of 20 L was washed and dried, and replaced with dry nitrogen. Then, 10.2 kg of industrial hexane (density 680 kg/m³), 608 g of 1,3-butadiene, 192 g of styrene, 6.1 ml of tetrahydrofuran, and 4.4 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was placed into the polymerization reactor.

Into the polymerization reactor was placed 2.63 g of bis(diethylamino)methylvinylsilane, thereafter, a solution of n-butyllithium in n-hexane (content of n-butyllithium: 12.3 mmol) as a polymerization initiator component was placed into the polymerization reactor, and a polymerization reaction was initiated. The copolymerization reaction of 1,3-butadiene, styrene and bis(diethylamino)methylvinylsilane was performed for 3 hours at a stirring rate of 130 rpm and a temperature in the polymerization reactor of 65° C., while 1,3-butadiene and styrene were continuously supplied into the polymerization reactor. The amounts of 1,3-butadiene and styrene supplied after initiation of the polymerization reaction were 912 g and 288 g, respectively. The amount of bis(diethylamino)methylvinylsilane placed was 0.13 wt % in the total amount of monomers which had been placed or supplied into the polymerization reactor.

To the polymer solution was added 20 ml of a hexane solution containing 0.8 ml of methanol, and the polymer solution was stirred for 5 minutes. Then, to the polymerization solution were added 8.0 g of 2-tert-butyl-6-(3-tert-butyl-2-hydroxy-5-methylbenzyl)-4-methylphenyl acrylate (trade name: Sumilizer GM manufactured by Sumitomo Chemical Co., Ltd.), and 4.0 g of pentaerythrityltetrakis(3-laurylthiopropionate) (trade name: Sumilizer TP-D manufactured by Smitomo Chemical Co., Ltd.), then, the polymerization solution was allowed to stand under room temperature for 24 hours, and the solvent was evaporated to obtain a polymer. Thereafter, the resulting polymer was further dried at 55° C. for 12 hours under reduced pressure. The evaluation results of the polymer are shown in Table 1.

One hundred parts by weight of the resulting polymer, 78.4 parts by weight of silica (trade name: Ultrasil VN3-G, manufactured by Degussa), 6.4 parts by weight of a silane coupling agent (trade name: Si69, manufactured by Degussa), 6.4 parts by weight of carbon black (trade name: Diablack N339, manufactured by Mitsubishi Chemical Corporation), 47.6 parts by weight of an extender oil (trade name: JOMO Process NC-140, manufactured by Japan Energy Corporation), 1.5 parts by weight of an anti-aging agent (trade name: Antigen 3C, manufactured by Sumitomo Chemical Co., Ltd.), 2 parts by weight of stearic acid, 2 parts by weight of zinc flower, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes for vulcanization to prepare a vulcanized sheet. The evaluation results of physical properties of the vulcanized sheet are shown in Table 1. Comparative Example 2

The interior of a polymerization reactor made of stainless steel, equipped with a stirring device, and having an internal volume of 20 L was washed and dried, and replaced with dry nitrogen. Then, 10.2 kg of industrial hexane (density 680 kg/m³), 608 g of 1,3-butadiene, 192 g of styrene, 6.1 ml of tetrahydrofuran, and 5.2 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was placed into the polymerization reactor.

A solution of n-butyllithium in n-hexane (content of n-butyllithium: 15.6 mmol) as a polymerization initiator, thereafter, 1.11 g (1.01 mol per 1 mol of n-butyllithium) of pyrrolidine were immediately placed into the polymerization reactor, and a polymerization reaction was initiated. The copolymerization reaction of 1,3-butadiene and styrene was performed for 3 hours at a stirring rate of 130 rpm and a temperature in the polymerization reactor of 65° C., while 1,3-butadiene and styrene were continuously supplied into the polymerization reactor. The amounts of 1,3-butadiene and styrene supplied after initiation of the polymerization reaction were 912 g and 288 g, respectively.

To the polymer solution was added 20 ml of a hexane solution containing 1.0 ml of methanol, and the polymer solution was stirred for 5 minutes. Then, to the polymerization solution were added 8.0 g of 2-tert-butyl-6-(3-tert-butyl-2-hydroxy-5-methylbenzyl)-4-methylphenyl acrylate (trade name: Sumilizer GM manufactured by Sumitomo Chemical Co., Ltd.) and 4.0 g of pentaerythrityltetrakis(3⁻laurylthiopropionate) (trade name: Sumilizer TP-D manufactured by Sumitomo Chemical Co., Ltd.), then, the polymerization solution was allowed to stand under room temperature for 24 hours, and the solvent was evaporated to obtain a polymer. Thereafter, the resulting polymer was further dried at 55° C. for 12 hours under reduced pressure. The evaluation results of the polymer are shown in Table 1.

One hundred parts by weight of the resulting polymer, 78.4 parts by weight of silica (trade name: Ultrasil VN3-G, manufactured by Degussa), 6.4 parts by weight of a silane coupling agent (trade name: Si69, manufactured by Degussa), 6.4 parts by weight of carbon black (trade name: Diablack N339, manufactured by Mitsubishi Chemical Corporation), 47.6 parts by weight of an extender oil (trade name: JOMO Process NC-140, manufactured by Japan Energy Corporation), 1.5 parts by weight of an anti-aging agent (trade name: Antigen 3C, manufactured by Sumitomo Chemical Co., Ltd.), 2 parts by weight of stearic acid, 2 parts by weight of zinc flower, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes for vulcanization to prepare a vulcanized sheet. The evaluation results of physical properties of the vulcanized sheet are shown in Table 1.

### Comparative Example 3

The interior of a polymerization reactor made of stainless steel, equipped with a stirring device, and having an internal volume of 30 L was washed and dried, and replaced with dry nitrogen. Then, 15.3 kg of industrial hexane (density 680 kg/m³), 912 g of 1,3-butadiene, 288 g of styrene, 9.1 ml of tetrahydrofuran, and 8.0 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was placed into the polymerization reactor.

A solution of n-butyllithium in n-hexane (content of n-butyllithium: 22.2 mmol) as a polymerization initiator was placed into the polymerization reactor, thereafter, 2.20 g (1.01 mol per 1 mol of n-butyllithium) was immediately placed into the polymerization reactor, and a polymerization reaction was initiated. The copolymerization reaction of 1,3-butadiene and styrene was performed for 3 hours at a stirring rate of 130 rpm and a temperature in the polymerization reactor of 65° C., while 1,3-butadiene and styrene were continuously supplied into the polymerization reactor. The amounts of 1,3-butadiene and styrene supplied after initiation of the polymerization reaction were 1368 g and 432 g, respectively.

To the polymer solution was added 20 ml of a hexane solution containing 1.4 ml of methanol, and the polymer solution was stirred for 5 minutes. Then, to the polymerization solution were added 12.0 g of 2-tert-butyl-6-(3-tert-butyl-2-hydroxy-5-methylbenzyl)-4-methylphenyl acrylate (trade name: Sumilizer GM manufactured by Sumitomo Chemical Co., Ltd.) and 6.0 g of pentaerythrityltetrakis(3-laurylthiopropionate) (trade name: Sumilizer TP-D manufactured by Sumitomo Chemical Co., Ltd.), then, the polymerization solution was allowed to stand under room temperature for 24 hours, and the solvent was evaporated to obtain a polymer. Thereafter, the resulting polymer was further dried at 55° C. for 12 hours under reduced pressure. The evaluation results of the polymer are shown in Table 1.

One hundred parts by weight of the resulting polymer, 78.4 parts by weight of silica (trade name: Ultrasil VN3-G, manufactured by Degussa), 6.4 parts by weight of a silane coupling agent (trade name: Si69, manufactured by Degussa), 6.4 parts by weight of carbon black (trade name: Diablack N339, manufactured by Mitsubishi Chemical Corporation), 47.6 parts by weight of an extender oil (trade name: JOMO Process NC-140, manufactured by Japan Energy Corporation), 1.5 parts by weight of an anti-aging agent (trade name: Antigen 3C, manufactured by Sumitomo Chemical Co., Ltd.), 2 parts by weight of stearic acid, 2 parts by weight of zinc flower, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes for vulcanization to prepare a vulcanized sheet. The evaluation results of physical properties of the vulcanized sheet are shown in Table 1.

TABLE 1

| | | | | Comparative | Comparative | Comparative |
|---|---|---|---|---|---|---|
| | | Example 1 | Example 2 | Example 1 | Example 2 | Example 3 |
| Mooney | — | 46.7 | 43.0 | 40.9 | 48.3 | 43.5 |
| viscosity | | | | | | |
| Vinyl bonding | mol % | 56.3 | 56.9 | 57.6 | 56.7 | 57.9 |
| amount | | | | | | |
| Content of | wt % | 24.3 | 24.4 | 24.4 | 24.4 | 24.3 |
| styrene unit | | | | | | |
| Molecular | — | 1.29 | 1.16 | 1.09 | 1.25 | 1.16 |
| weight | | | | | | |
| distribution | | | | | | |
| Fuel cost | — | 0.109 | 0.119 | 0.141 | 0.195 | 0.194 |
| saving | | | | | | |
| properties | | | | | | |
| tanδ (70° C.) | | | | | | |
| Gripping | | 0.661 | 0.706 | 0.667 | 0.612 | 0.641 |
| property | | | | | | |
| tanδ (0° C.) | | | | | | |
| Tensile | MPa | 15.9 | 14.1 | 14.3 | 14.4 | 14.2 |
| strength at | | | | | | |
| break | | | | | | |

### Example 3

The interior of a polymerization reactor made of stainless steel, equipped with a stirring device, and having an internal volume of 20 L was washed and dried, and replaced with dry nitrogen. Then, 10.2 kg of industrial hexane (density 680 kg/m³), 608 g of 1,3-butadiene, 192 g of styrene, 6.1 ml of tetrahydrofuran, and 5.5 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was placed into the polymerization reactor.

Into the polymerization reactor was placed 2.74 g of bis(diethylamino)methylvinylsilane. Then, a solution of n-butyllithium in n-hexane (content of n-butyllithium: 17.1 mmol) as a polymerization initiator component was placed into the reaction reactor, thereafter, 1.22 g (1.02 mol per 1 mol of n-butyllithium) of pyrrolidine was immediately placed, and a polymerization reaction was initiated. The copolymerization reaction of 1,3-butadiene, styrene and bis(diethylamino)methylvinylsilane was performed for 3 hours at a stirring rate of 130 rpm and a temperature in the polymerization reactor of 65° C., while 1,3-butadiene and styrene were continuously supplied into the polymerization reactor. The amounts of 1,3-butadiene and styrene supplied after initiation of the polymerization reaction were 912 g and 288 g, respectively. The amount of bis(diethylamino)methylvinylislane placed was 0.14 wt % in the total amount of monomers which had been placed or supplied into the polymerization reactor.

Then, the resulting polymerization solution was stirred at a stirring rate of 130 rpm, 17.1 mmol of N-(3-dimethylaminopropyl)acrylamide was added to the polymerization solution, and the mixture was stirred for 15 minutes.

To the polymer solution was added 20 ml of a hexane solution containing 1.2 ml of methanol, and the polymer solution was stirred for 5 minutes. Then, to the polymerization solution were added 8.0 g of 2-tert-butyl-6-(3-tert-butyl-2-hydroxy-5-methylbenzyl)-4-methylphenyl acrylate (trade name: Sumilizer GM manufactured by Sumitomo Chemical Co., Ltd.) and 4.0 g of pentaerythrityltetrakis(3-laurylthiopropionate) (trade name: Sumilizer TP-D manufactured by Sumitomo Chemical Co., Ltd.), then, the polymerization solution was allowed to stand under room temperature for 24 hours, and the solvent was evaporated to obtain a polymer. Thereafter, the resulting polymer was further dried at 55° C. for 12 hours under reduced pressure. The evaluation results of the polymer are shown in Table 2.

One hundred parts by weight of the resulting polymer, 78.4 parts by weight of silica (trade name: Ultrasil VN3-G, manufactured by Degussa), 6.4 parts by weight of a silane coupling agent (trade name: Si69, manufactured by Degussa), 6.4 parts by weight of carbon black (trade name: Diablack N339, manufactured by Mitsubishi Chemical Corporation), 47.6 parts by weight of an extender oil (trade name: JOMO Process NC-140, manufactured by Japan Energy Corporation), 1.5 parts by weight of an anti-aging agent (trade name: Antigen 3C, manufactured by Sumitomo Chemical Co., Ltd.), 2 parts by weight of stearic acid, 2 parts by weight of zinc flower, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes for vulcanization to prepare a vulcanized sheet. The evaluation results of physical properties of the vulcanized sheet are shown in Table 2.

### Example 4

The interior of a polymerization reactor made of stainless steel, equipped with a stirring device, and having an internal volume of 20 L was washed and dried, and replaced with dry nitrogen. Then, 10.2 kg of industrial hexane (density 680 kg/m³), 608 g of 1,3-butadiene, 192 g of styrene, 6.1 ml of tetrahydrofuran, and 5.1 ml of ethylene glycol diethyl ether were placed into the polymerization reactor. Then, in order to detoxify impurities causing inactivation of a polymerization initiator in advance, a small amount of a solution of n-butyllithium in n-hexane as a scavenger was placed into the polymerization reactor.

Into the polymerization reactor was placed 2.74 g of bis(diethylamino)methylvinylsilane. Then, a solution of n-butyllithium in n-hexane (content of n-butyllithium: 13.0 mmol) as a polymerization initiator component was placed into the polymerization reactor, thereafter, 1.11 g (1.00 mol per 1 mol of n-butyllithium) of piperidine was immediately placed, and a polymerization reaction was initiated. The copolymerization reaction of 1,3-butadiene, styrene and bis(diethylamino)methylvinylsilane was performed for 3 hours at a stirring rate of 130 rpm and a temperature in the polymerization reactor of 65° C., while 1,3-butadiene and styrene were continuously supplied into the polymerization reactor. The amounts of 1,3-butadiene and styrene supplied after initiation of the polymerization reaction were 912 g and 288 g, respectively. The amount of bis(diethylamino)methylvinylislane placed was 0.14 wt % in the total amount of monomers which had been placed or supplied into the polymerization reactor.

Then, the resulting polymerization solution was stirred at a stirring rate of 130 rpm, 13.02 mmol of N-(3-dimetylaminopropyl)acrylamide was added to the polymerization solution, and the mixture was stirred for 15 minutes.

To the polymer solution was added 20 ml of a hexane solution containing 1.0 ml of methanol, and the polymer solution was stirred for 5 minutes. Then, to the polymerization solution were added 8.0 g of 2-tert-butyl-6-(3-tert-butyl-2-hydroxy-5-methylbenzyl)-4-methylphenyl acrylate (trade name: Sumilizer GM manufactured by Sumitomo Chemical Co., Ltd.) and 4.0 g of pentaerythrityltetrakis(3-laurylthiopropionate) (Sumilizer TP-D manufactured by Sumitomo Chemical Co., Ltd.), then, the polymerization solution was allowed to stand under room temperature for 24 hours, and the solvent was evaporated to obtain a polymer. Thereafter, the resulting polymer was further dried at 55° C. for 12 hours under reduced pressure. The evaluation results of the polymer are shown in Table 2.

One hundred parts by weight of the resulting polymer, 78.4 parts by weight of silica (trade name: Ultrasil VN3-G, manufactured by Degussa), 6.4 parts by weight of a silane coupling agent (trade name: Si69, manufactured by Degussa), 6.4 parts by weight of carbon black (trade name: Diablack N339, manufactured by Mitsubishi Chemical Corporation), 47.6 parts by weight of an extender oil (trade name: JOMO Process NC-140, manufactured by Japan Energy Corporation), 1.5 parts by weight of an anti-aging agent (trade name: Antigen 3C, manufactured by Sumitomo Chemical Co., Ltd.), 2 parts by weight of stearic acid, 2 parts by weight of zinc flower, 1 part by weight of a vulcanization accelerator (trade name: Soxinol CZ, manufactured by Sumitomo Chemical Co., Ltd.), 1 part by weight of a vulcanization accelerator (trade name: Soxinol D, manufactured by Sumitomo Chemical Co., Ltd.), 1.5 parts by weight of a wax (trade name: Sunnoc N, manufactured by Ouchi Shinko Chemical Industrial Co., Ltd.), and 1.4 parts by weight of sulfur were kneaded with Laboplast Mill to prepare a polymer composition. The resulting polymer composition was molded into a sheet with a 6 inch roll, and the sheet was heated at 160° C. for 45 minutes for vulcanization to prepare a vulcanized sheet. The evaluation results of physical properties of the vulcanized sheet are shown in Table 2.

TABLE 2

| | | Example 3 | Example 4 |
|---|---|---|---|
| Mooney viscosity | — | 41.9 | 39.4 |
| Vinyl bonding | mol % | 56.7 | 58.0 |
| amount | | | |
| Content of styrene | wt % | 24.3 | 24.2 |
| unit | | | |
| Molecular weight | — | 1.39 | 1.11 |
| distribution | | | |
| Fuel cost saving | — | 0.109 | 0.108 |
| properties | | | |
| tanδ (70° C.) | | | |
| Gripping property | | 0.681 | 0.715 |
| Tensile strength at | MPa | 15.9 | 13.3 |
| break | | | |

1. A process for producing a conjugated diene-based polymer comprising adding the following compounds (I) and (II):
(I) Organic alkali metal compound;
(II) Compound represented by the following formula (I) 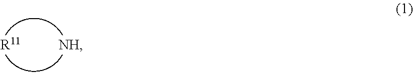
wherein R¹¹ represents a hydrocarbylene group having 3 to 20 carbon atoms optionally having, as a hetero atom, at least one kind atom selected from an atomic group consisting of a silicon atom, a nitrogen atom and an oxygen atom,
as a polymerization initiator component to a solution containing at least one kind monomer component and using a hydrocarbon as a solvent, in an order of the compound (I) and the compound (II), and polymerizing a monomer component comprising a conjugated diene-compound and a silicon-containing vinyl compound.

2. The process for producing a conjugated diene-based polymer according to claim 1, wherein the compound (II) is added to the solution, while a polymerization conversion rate of the monomer component is 5 wt % or less.

3. The process for producing a conjugated diene-based polymer according to claim 2, wherein an amount of the compound (II) which is added while a polymerization conversion rate of the monomer component is 5 wt % or less is 0.5 mol to 2.0 mol based on 1 mol of the addition amount of the compound (I).

4. The process for producing a conjugated diene-based polymer according to claim 1, wherein a compound containing a nitrogen atom and/or a silicon atom is allowed to react with an active end of a polymer produced by polymerization.

5. The process for producing a conjugated diene-based polymer according to claim 4, wherein the compound containing a nitrogen atom and/or a silicon atom is a compound containing a nitrogen atom and a carbonyl group.

6. A conjugated diene-based polymer produced by the process according to claim 1.

7. A conjugated diene-based polymer composition comprising the conjugated diene-based polymer according to claim 6 and a reinforcing agent, wherein the content of the reinforcing agent is 10 parts by weight to 150 parts by weight, per 100 parts by weight of the conjugated diene-based polymer.
